(19) United States
(12) Patent Application Publication
(10) Pub. No.: US 2021/0177549 A1
(43) Pub. Date: Jun. 17, 2021

(54) MEDICAL ARTICLES WITH MICROSTRUCTURED SURFACE HAVING INCREASED MICROORGANISM REMOVAL WHEN CLEANED AND METHODS THEREOF

(71) Applicant: 3M INNOVATIVE PROPERTIES COMPANY, St. Paul, MN (US)

(72) Inventors: Jodi L. Connell, St. Paul, MN (US); Raymond P. Johnston, Lake Elmo, MN (US); Karl J.L. Geisler, St. Paul, MN (US); Brian W. Lueck, Houlton, WI (US); John J. Sullivan, Hudson, WI (US); Vivian W. Jones, Woodbury, MN (US); Gordon A. Kuhnley, St. Paul, MN (US)

(21) Appl. No.: 17/182,522

(22) Filed: Feb. 23, 2021

Related U.S. Application Data
(63) Continuation-in-part of application No. PCT/IB2020/057809, filed on Aug. 19, 2019.

(51) Int. Cl. A61C 7/08; A61C 19/00; B08B 1/00; B08B 3/04

(52) U.S. Cl. CPC A61C 7/08; A61C 19/002; B08B 1/006; B08B 3/04; B08B 1/002

(57) ABSTRACT

The present invention describes medical articles having a microstructured surface, methods of preparing such medical articles, and methods of cleaning medical articles having microstructured surface(s).

### CROSS REFERENCE TO RELATED APPLICATIONS

This application is a continuation-in-part of PCT Application No. IB2020/057809, filed Aug. 19, 2019 and claims priority to U.S. Application No. 62/889191, filed Aug. 20, 2019; the disclosures of which is incorporated by reference in its/their entirety herein.

### BACKGROUND

Biofilms are structured communities of microorganisms encased in an extracellular polymeric matrix that are typically tenaciously adhered to the surface of materials and host tissue. The formation of biofilms is often referred to as biofouling. Any article in contact with aqueous or bodily fluid is likely to become fouled. Bacteria living in a biofilm are considerably more resistant to host defenses, antibiotic or antimicrobial treatments, and cleaning, thus increasing the potential for infection during the use of any such device.

Medical articles can easily become contaminated with biofilm-forming microorganisms, especially articles used in the mouth of a patient. Microorganism and biofilm buildup can not only lead to various periodontal diseases, but also discolor the article and produce undesirable tastes and odors. In many cases, buildup is difficult to remove, even with periodic cleaning.

Attempts have been made to provide surfaces that are inherently anti-fouling. For example, US2017/0100332 (abstract) describes an article that includes a first plurality of spaced features. The spaced features are arranged in a plurality of groupings; the groupings of features include repeat units; the spaced features within a grouping are spaced apart at an average distance of about 1 nanometer to about 500 micrometers; each feature having a surface that is substantially parallel to a surface on a neighboring feature; each feature being separated from its neighboring feature; the groupings of features being arranged with respect to one another so as to define a tortuous pathway. The plurality of spaced features provide the article with an engineered roughness index of about 5 to about 20.

Further attempts to provide anti-fouling surfaces include WO2013/003373 and WO 2012/058605, which describe microstructure features for resisting and reducing biofilm formation, particularly on medical articles.

### SUMMARY

Although articles with specific microstructure features are useful for reducing the initial formation of a biofilm, particularly for implantable medical articles; in the case of other articles, such microstructured surfaces can be difficult to clean. This is surmised to be due at least in part to the bristles of a brush or fibers of a (e.g. nonwoven) wipe being larger than the space between microstructures. Surprisingly, it has been found that some types of microstructured surfaces exhibit better bacteria removal when cleaned, even in comparison to smooth surfaces.

In one embodiment, a medical article is provided. The medical article may include a base member and a microstructured surface disposed on one or more surfaces of the base member. The microstructured surface may include an array of peak structures and adjacent valleys. The valleys may have a maximum width ranging from 10 microns to 250 microns. The peak structures may have a side wall angle greater than 10 degrees. In some embodiments, the medical article is a dental article that would typically be cleaned and reused during its normal use such as a dental tray, including mouthguards and aligners.

In one embodiment, a method of preparing a medical article having a surface with increased microorganism (e.g., bacteria) removal when physically cleaned is provided. The method may include providing a base member having a microstructured surface disposed on one or more surfaces of a base member. The microstructured surface may include an array of peak structures and adjacent valleys. The valleys may have a maximum width ranging from 10 microns to 250 microns. The peak structures may have a side wall angle greater than 10 degrees.

In another embodiment, a method of cleaning a medical article having a surface with increased microorganism (e.g., bacteria) removal when cleaned is provided. The method may include providing the medical article having a microstructured surface as described herein, and cleaning the microstructured surface.

### BRIEF DESCRIPTION OF DRAWINGS

FIG. 1 is a perspective review of a Cartesian coordinate system of a surface that can be utilized to describe various microstructured surfaces.

FIG. 2 is a cross-sectional view of a microstructured surface.

FIG. 3 is a perspective view of a microstructured surface comprising a linear array of prisms.

FIG. 4A is a perspective view of a microstructured surface comprising an array of cube corner elements.

FIG. 4B is a perspective view of a microstructured surface comprising an array of pyramid elements.

FIG. 5 is a perspective view of a microstructured surface comprising an array of preferred geometry cube corner elements.

FIG. 6 is a cross-sectional view of peak structures with various apex angles.

FIG. 7 is a cross-sectional view of peak structures with a rounded apexes.

FIG. 8 is a cross-sectional view of peak structures with planar apexes.

FIG. 9 is a schematic overhead perspective view of a dental aligner.

### DETAILED DESCRIPTION

### Medical Articles

In various embodiments, a medical article is described. The medical article may include a base member and a microstructured surface disposed on one or more surfaces of the base member. The microstructured surface may include an array of peak structures and adjacent valleys. The valleys may have a maximum width ranging from 10 microns to 250 microns. The peak structures may have a side wall angle greater than 10 degrees.

As described herein, a “medical article” includes any object that may be used on, or at least partially within, a human or animal body. In some embodiments, a medical article may assist or improve a body function. In other embodiments, a medical article may be an object to alter aesthetics. In many embodiments, a medical article is an object that is frequently in contact with skin and/or bodily fluids and is not typically subject to a sterilization process.

In many embodiments, the medical article may include any of the microstructure surfaces and features thereof described herein. Various microstructure surfaces discussed herein include a planar base layer reference point to which one or more microstructure feature are described. It is to be understood that in some instances, the term “planar base layer” used below may be interchanged with the term “base member” in order to describe microstructure surface features of the present invention. For example, in some embodiments, adjacent peak structures may be interconnected proximate the base member in at least one direction. Further, for example, the peak structures and valleys may be free of flat surface area relative to the (e.g., planar) base member. For example, the peak structures and/or valleys may be truncated such that the microstructured surface may include less than 50, 40, 30, 20 or 10% of flat surface area relative to the (e.g., planar) base member. For example, in other embodiments, the base member and peak structures are comprised of the same or different materials. In some embodiments, the base member and peak structures are comprised of the same organic polymeric material. The microstructured surface and the base member may independently be transparent, light-transmissive, or opaque.

In some embodiments, the medical article may further include an adhesive or primer between the base member and the microstructured surface. The adhesive may include any adhesive described herein.

Examples of medical articles of the present invention, or medical articles prepared by the methods disclosed herein, include but are not limited to: dental trays, nasal gastric tubes, wound contact layers, wound dressings, blood stream catheters, stents, pacemaker shells, heart valves, periodontal implants, dentures, dental crowns, contact lenses, intraocular lenses, soft tissue implants (breast implants, penile implants, facial and hand implants, etc.), surgical tools, sutures including degradable sutures, cochlear implants, tympanoplasty tubes, shunts including shunts for hydrocephalus, post-surgical drain tubes and drain devices, urinary catheters, endotraecheal tubes, other implantable devices, and other indwelling devices

In another embodiment, the medical article may be dental tray. As used herein, a “dental tray” may include an article shaped to at least partially overlay one or more teeth, gums, or dental implants. In some embodiments, a dental tray has an arch shape. As used herein, the term “arch” refers to a semi-circular shape. For example, a dental tray may be a dental aligner (e.g. orthodontic aligner or retainer), a night guard, a mouth guard, a treatment tray, complete or partial dentures, a tooth cap, or the like. A dental aligner may allow for repositioning misaligned teeth for improved cosmetic appearances and/or dental function. A night guard may be worn by a user to prevent teeth grinding A mouth guard may be, for example, a sports mouth guard that may or may not be formed to a user's mouth with heat. A treatment tray may allow administration of a medication to oral surfaces, e.g., teeth whitening, remineralization, gum disease treatments, or the like. In some embodiments, the dental tray may provide aesthetic appeal by providing color (e.g. whitening). In another embodiment, the medical article may be a dental splint, a palatal expander, a sleep apnea oral appliance, or a nociceptive trigeminal inhibition tension suppression system (NTI-tss).

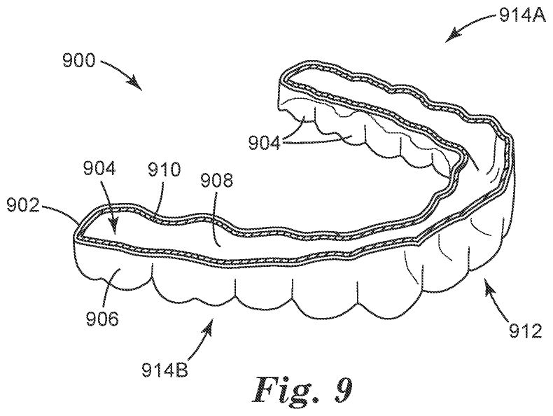

FIG. 9 is a schematic overhead perspective view of a dental aligner 900. Dental aligner 900 includes a base member 902 with a plurality of cavities 904. Cavities 904 are shaped to receive and resiliently reposition one or more teeth in an upper or lower jaw of a patient from one tooth arrangement to a successive tooth arrangement, or to receive and maintain the position of the previously realigned one or more teeth. Base member 902 includes a first major external surface 906 and a second major internal surface 908 that contacts the teeth of a patient. At least one of first major external surface 906 and second major internal surface 908 includes a layer of microstructured surfaces. As depicted, microstructured surface layer 910 spans second major internal surface 908. In some embodiments, dental aligner 900 includes an adhesive or primer between base member 902 and microstructured surface layer 910 (not shown). Base member 902 may further include a front 912, a left side 914A and a right side 914B. As shown, dental aligner 900 is shown as being shaped for an upper arch. Dental aligner 900 can also be shaped for a lower arch.

Base member 902 of dental aligner 900 may include an elastic polymeric material that generally conforms to a patient's teeth, and may be transparent, translucent, or opaque. In some embodiments, base member 902 is clear or substantially transparent. In one embodiment, base member 902 is a substantially transparent polymeric material. As used herein, the phrase “substantially transparent” refers to materials that pass light in the wavelength region sensitive to the human eye (about 0.4 micrometers (μm) to about 0.75 μm) while rejecting light in other regions of the electromagnetic spectrum. In some embodiments, the reflective edge of the polymeric material selected for base member 902 should be above about 0.75 μm, just out of the sensitivity of the human eye.

In various embodiments, base member 902 has a thickness of less than 1 mm, but varying thicknesses may be used depending on the application of dental aligner 900. In various embodiments, base member 902 has a thickness of about 50 μm to about 3,000 μm, or about 300 μm to about 2,000 μm, or about 500 μm to about 1,000 μm, or about 600 μm to about 700 μm.

In some embodiments, microstructured surface layer 910 is substantially transparent to visible light of about 400 nm to about 750 nm when applied at a thickness of about 50 μm to about 1000 μm on a substantially transparent polymeric base member 902. In various embodiments, the visible light transmission through the combined thickness of base member 902 and microstructured surface layer 910 is at least about 50%, or about 75%, or about 85%, or about 90%, or about 95%.

Medical articles of the present invention may be formed or prepared by any method described herein.

### Methods

### Preparation

In another embodiment, a method of preparing a medical article having a surface with increased microorganism (e.g., bacteria) removal when cleaned is provided. The method may include providing a base member having a microstructured surface disposed on one or more surfaces of a base member and thermoforming the base member in the medical article. The microstructured surface may include an array of peak structures and adjacent valleys. The valleys may have a maximum width ranging from 10 microns to 250 microns. The peak structures may have a side wall angle greater than 10 degrees.

The term “cleaned” includes by any method of cleaning disclosed herein.

The microstructured surface may include any microstructured surface disclosed herein, or any combination of features thereof. In some embodiments, the method may further include providing the base member and disposing the microstructured surface upon the base member by any technique described herein. For example, the microstructured surface may be applied to the base member via casting and curing a polymerizable resin. In other embodiments, the microstructured surface may be disposed onto the base member, for example, as a microstructured film. The film may include any film described herein.

For example, the method may include bonding the microstructured surface to the base member with an adhesive. The adhesive may be any adhesive or combination of adhesives described herein. For example, a base member and microstructured surface of different materials may be bonded with an adhesive.

In some embodiments, the base member is planar. In other embodiments, the base member is non-planar.

The medical articles and microstructured surfaces can be formed by a variety of methods, including a variety of microreplication methods, including, but not limited to, casting and curing polymerizable resin, coating, injection molding, and/or compressing techniques. For example, microstructuring of the (e.g. engineered) surface can be achieved by at least one of (1) casting a molten thermoplastic using a tool having a microstructured pattern, (2) coating of a fluid onto a tool having a microstructured pattern, solidifying the fluid, and removing the resulting film, (3) passing a thermoplastic film through a nip roll to compress against a tool having a microstructured pattern (i.e., embossing), and/or (4) contacting a solution or dispersion of a polymer in a volatile solvent to a tool having a microstructured pattern and removing the solvent, e.g., by evaporation. The tool can be formed using any of a number of techniques known to those skilled in the art, selected depending in part upon the tool material and features of the desired topography. Illustrative techniques include etching (e.g., chemical etching, mechanical etching, or other ablative means such as laser ablation or reactive ion etching, etc., and combinations thereof), photolithography, stereolithography, micromachining, knurling (e.g., cutting knurling or acid enhanced knurling), scoring, cutting, etc., or combinations thereof.

Alternative methods of forming the (e.g. engineered) microstructured surface include thermoplastic extrusion, curable fluid coating methods, and embossing thermoplastic layers, which can also be cured. Additional information regarding materials and various processes for forming the (e.g. engineered) microstructured surface can be found, for example, in Halverson et al., PCT Publication No. WO 2007/070310 and US Publication No. US 2007/0134784; Hanschen et al., US Publication No. US 2003/0235677; Graham et al., PCT Publication No. WO2004/000569; Ylitalo et al., U.S. Pat. No. 6,386,699; Johnston et al., US Publication No. US 2002/0128578 and U.S. Pat. Nos. 6,420,622, 6,867,342, 7,223,364 and Scholz et al., U.S. Pat. No. 7,309,519.

### Cleaning

In another embodiment, a method of cleaning a medical article having a surface with increase microorganism (e.g., bacteria) removal when cleaned is provided. The method may include providing the medical article having a base member and a microstructured surface as described herein, and cleaning the microstructured surface.

The phrase “increased microorganism removal when cleaned” as used herein, means an increase in microorganism removal as compared to a non-microstructured surface.

The term “microorganism” is generally used to refer to any prokaryotic or eukaryotic microscopic organism, including without limitation, one or more of bacteria (e.g., motile or nonmotile, vegetative or dormant, Gram positive or Gram negative, planktonic or living in a biofilm), bacterial spores or endospores, algae, fungi (e.g., yeast, filamentous fungi, fungal spores), mycoplasmas, parasites, viruses, algae, archaea, and protozoa, as well as combinations thereof. In some cases, the microorganisms of particular interest are those that are pathogenic, and the term “pathogen” is used to refer to any pathogenic microorganism. Examples of pathogens can include, but are not limited to, both Gram positive and Gram negative bacteria, fungi, and viruses including members of the family Enterobacteriaceae, or members of the family Micrococaceae, or the genera Staphylococcus spp., Streptococcus, spp., Pseudomonas spp., Acinetobacter spp., Enterococcus spp., Salmonella spp., Legionella spp., Shigella spp., Yersinia spp., Enterobacter spp., Escherichia spp., Bacillus spp., Listeria spp., Campylobacter spp., Acinetobacter spp., Vibrio spp., Clostridium spp., Klebsiella spp., Proteus spp. Aspergillus spp., Candida spp., and Corynebacterium spp. Particular examples of pathogens can include, but are not limited to, Escherichia coli including enterohemorrhagic E. coli e.g., serotype O157:H7, 0129:H11; Pseudomonas aeruginosa; Bacillus cereus; Bacillus anthracia; Salmonella enteritidis; Salmonella enterica serotype Typhimurium; Listeria monocytogenes; Clostridium botulinum; Clostridium perfringens; Staphylococcus aureus; methicillin-resistant Staphylococcus aureus; carbapenem-resistant Enterobacteriaceae, Campylobacter jejuni; Yersinia enterocolitica; Vibrio vulnificus; Clostridium difficile; vancomycin-resistant Enterococcus; Klebsiella pnuemoniae; Proteus mirabilus and Enterobacter [Cronobacter] sakazakii.

In some embodiments, the method may include one or more of: wiping the microstructured surface with a woven or non-woven material, scrubbing the microstructured surface with a brush, applying an antimicrobial solution to the microstructured surface, or any combination thereof In some embodiments, the fibers of the woven or non-woven material have a fiber diameter less than the maximum width of the valleys. In some embodiments, the bristles of the brush have a diameter less than the maximum width of the valleys. Alternatively, the microstructured surface may be cleaned by applying an antimicrobial (e.g. antibacterial) solution to the microstructured surface. Further, the microstructured surface can also be cleaned by (e.g. ultraviolet) radiation-based disinfection. Combinations of such cleaning technique can be used.

The antimicrobial solution contains an antiseptic component. Various antiseptic components are known including for example biguanides and bisbiguanides such as chlorhexidine and its various salts including but not limited to the digluconate, diacetate, dimethosulfate, and dilactate salts, as well as combinations thereof, polymeric quaternary ammonium compounds such as polyhexamethylenebiguanide; silver and various silver complexes; small molecule quaternary ammonium compounds such as benzalkoium chloride and alkyl substituted derivatives; di-long chain alkyl (C8-C18) quaternary ammonium compounds; cetylpyridinium halides and their derivatives; benzethonium chloride and its alkyl substituted derivatives; octenidine and compatible combinations thereof. In other embodiments, the antiseptic component may be a cationic antimicrobial or oxidizing agent such as hydrogen peroxide, peracetic acid, bleach.

In some embodiments, the antiseptic component is a small molecule quaternary ammonium compounds. Examples of preferred quaternary ammonium antiseptics include benzalkonium halides having an alkyl chain length of C8-C18, more preferably C12-C16, and most preferably a mixture of chain lengths. For example, a typical benzalkonium chloride sample may be comprise of 40% C12 alkyl chains, 50% C14 alkyl chains, and 10% C16 alkyl chains. These are commercially available from numerous sources including Lonza (Barquat MB-50); Benzalkonium halides substituted with alkyl groups on the phenyl ring. A commercially available example is Barquat 4250 available from Lonza; dime thyldialkylammonium halides where the alkyl groups have chain lengths of C8-C18. A mixture of chain lengths such as mixture of dioctyl, dilauryl, and dioctadecyl may be particularly useful. Exemplary compounds are commercially available from Lonza as Bardac 2050, 205M and 2250 from Lonza; Cetylpyridinium halides such as cetylpyridinium chloride available from Merrell labs as Cepacol Chloride; Benzethonium halides and alkyl substituted benzethonium halides such as Hyamine 1622 and Hyamine 10.times. available from Rohm and Haas; octenidine and the like.

In one embodiment, the disinfectant solution kills HIV-1, HBV, MRSA, VRE, KPC, Acinetobacter and other pathogens in 3 minutes. The aqueous disinfectant solution may contain a 1:256 dilution of a disinfectant concentrate containing benzyl-C12-16-alkyldimethyl ammonium chlorides (8.9 wt. %) octyldecyldimethylammonium chloride (6.67 wt. %), dioctyl dimethyl ammonium chloride (2.67 wt. %), surfactant (5-10%), ethyl alcohol (1-3 wt-%) and chelating agent (7-10 wt. %) adjusted to a pH of 1-3.

The presently described microstructured surfaces do not prevent bacteria such as Streptococcus mutans, Staphylococcus aureus, or Pseuodomonas aeruginosa from being presented on the microstructured surface, or in other words, does not prevent biofilm from forming. As evidenced by the forthcoming examples, both smooth, planar surfaces and the microstructured surfaces described herein had about the same amount of bacteria present; i.e. in excess of 80 colony forming units, prior to cleaning.

However, as also evidenced by the forthcoming examples, the presently described microstructured surface is easier to clean, providing a low amount of bacteria present after cleaning. Without intending to be bound by theory, scanning electron microscopy images suggest that large continuous biofilms typically form on a smooth surface. However, even though the peaks and valleys are much larger than the microorganism (e.g. bacteria), the biofilm is interrupted by the microstructured surface. In some embodiments, the biofilm (before cleaning) is present as discontinuous aggregate and small groups of cells on the microstructured surface, rather than a continuous biofilm. After cleaning, biofilm aggregates in small patches cover the smooth surface. However, the microstructured surface was observed to have only small groups of cells and individual cells after cleaning. In favored embodiments, the microstructured surface can provide a log 10 reduction of microorganism (e.g. bacteria such as Streptococcus mutans, Staphylococcus aureus, Pseuodomonas aeruginosa, or Phi6 Bacteriophage) of at least 2, 3, 4, 5, 6, 7 or 8 after cleaning.

In some embodiments, the microstructured surface can prevent an aqueous or (e.g. isopropanol) alcohol-based cleaning solution from beading up as compared to a smooth surface comprised of the same polymeric (e.g. thermoplastic, thermoset, or polymerized resin) material. When a cleaning solution beads up or in other words dewets, the disinfectant agent may not be in contact with a microorganism for a sufficient duration of time to kill the microorganism. However, it has been found that at least 50, 60, 70, 80, or 90% of the microstructured surface can comprise cleaning solution 1, 2, and 3 minutes after applying the cleaning solution to the microstructured surface (according to the test method described in the examples).

In some embodiments, the microstructured surface provides a reduction in microorganism (e.g. bacteria such as Streptococcus mutans, Staphyloccus aureus, Psueodomonas aeruginosa, or Phi6 Bacteriophage) touch transfer. The reduction is microorganism touch transfer can be at least 25, 30, 35, 40, 45, 50, 60, 70, 80, 90, 95, or 99% in comparison to the same smooth (e.g. unstructured) surface. The test methods for this property is described in the examples.

### Microstructure Surfaces

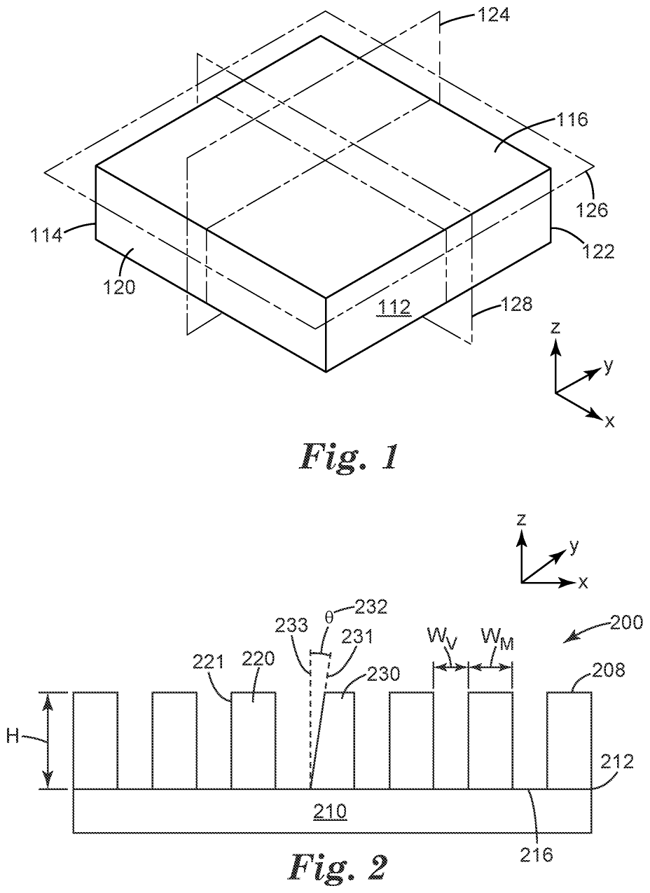

With reference to FIG. 1, a microstructured surface can be characterized in three-dimensional space by superimposing a Cartesian coordinate system onto its structure. A first reference plane 124 is centered between major surfaces 112 and 114. First reference plane 124, referred to as the y-z plane, has the x-axis as its normal vector. A second reference plane 126, referred to as the x-y plane, extends substantially coplanar with surface 116 and has the z-axis as its normal vector. A third reference plane 128, referred to as the x-z plane, is centered between first end surface 120 and second end surface 122 and has the y-axis as its normal vector. The medical articles are typically three-dimensional on a macroscale. However, on a microscale (e.g. surface area that includes at least two adjacent microstructures with a valley or channel disposed between the microstructures) the base layer/base member can be considered planar with respect to the microstructures. The width and length of the microstructures are in the x-y plane and the height of the microstructures is in the z-direction. Further, the base layer is parallel to the x-y plane and orthogonal to the z-plane.

FIG. 2 is an illustrative cross-section of a microstructured surface 200. Such cross-section is representative of a plurality of discrete (e.g. post or rib) microstructures 220. The microstructures comprises a base 212 adjacent an (e.g. engineered) planar surface 216 (surface 116 of FIG. 1 that is parallel to reference plane 126). Top (e.g. planar) surfaces 208 (parallel to surface 216 and reference plane 26 of FIG. 1) are spaced from the base 212 by the height (“H”) of the microstructure. The side wall 221 of microstructure 220 is perpendicular to planar surface 216. When the side wall 221 is perpendicular to planar surface 216, the microstructure has a side wall angle of zero degrees. Alternatively, microstructure 230 has side wall 231 that is angled rather than perpendicular relative to planar surface 216. The side wall angle 232 can be defined by the intersection of the side wall 231 and a reference plane 233 perpendicular to planar surface 216 (perpendicular to reference plane 126 and parallel to reference plane 128 of FIG. 1). In the case of privacy films, such as described in U.S. Pat. No. 9,335,449; the wall angle is typically less than 10, 9, 8, 7, 6, or 5 degrees. Larger wall angle can decrease transmission. However, as described herein, wall angles approaching zero degrees are also more difficult to clean.

Presently described are microstructured surfaces comprising microstructures having side wall angles greater than 1, 2, 3, 4, 5, 6, 7, 8, 9, or 10 degrees. In some embodiments, the side wall angle is at least 11, 12, 13, 14, 15, 16, 17, 18, 19, or 20 degrees. In other embodiments, the side wall angle is at least 21, 22, 23, 24, 25, 26, 27, 28, 29, or 30 degrees. For example, in some embodiments, the microstructure is a cube corner peak structure having a side wall angle of 30 degrees. In other embodiments, the side wall angle is at least 31, 32, 33, 34, 35, 36, 37, 38, 39, 40, 41, 42, 43, 44, or 45 degrees. For example, in some embodiments, the microstructure is a prism structure having a side wall angle of 45 degrees. In other embodiments, the side wall angle is at least 46, 47, 48, 49, 50, 51, 52, 53, 54, 55, 56, 57, 58, 59, or 60 degrees. It is appreciated that the microstructured surface would be beneficial even when some of the side walls have lower side wall angles. For example, if half of the array of peak structures have side wall angles are within the desired range, about half the benefit of improved bacteria removal may be obtained. Thus, in some embodiments, less than 50, 45, 40, 35, 30, 25, 20, 15, 10, 5 or 1% of the peak structures have side wall angles less than 10, 9, 8, 7, 6, 5, 4, 3, 2, or 1 degree. In some embodiments, less than 50, 45, 40, 35, 30, 25, 20, 15, 10, 5 or 1% of the peak structures have side wall angles less than 30, 25, 20, or 15 degrees.

In some embodiments, less than 50, 45, 40, 35, 30, 25, 20, 15, 10, 5 or 1% of the peak structures have side wall angles less than 40, 35, or 30 degrees. Alternatively at least 50, 60, 70, 80, 90, 95 or 99% of the peak structures have a sufficiently large side wall angle, as described above.

As described for example in WO 2013/003373, microstructures having a cross-sectional dimension no greater than 5 microns are believed to substantially interfere with the settlement and adhesion of target bacteria most responsible for HAIs or other biofouling problems such an increased drag, reduced heat transfer, filtration fouling etc. With reference to FIG. 2, the cross-sectional width of the microstructure (“W_{M}”) as depicted in this figure, is less than or equal to the cross-sectional width of the channel or valley (“W_{V}”) between adjacent microstructures. Thus, as depicted, when the cross-section width of the microstructure (W_{M}) is no greater than 5 microns, the cross-sectional width of the channel or valley (W_{V}) between microstructures is also no greater than 5 microns. When the microstructures on either side of a valley has a side wall angel of zero, such as depicted by microstructure 220 of FIG. 2, the channel or valley defined by the side wall has the same width (W_{M}) adjacent the top surface 208 are adjacent the bottom surface 212. When the microstructure has a side wall angle of greater than zero, such as depicted by the dashed line of microstructure 230, the valley typically has a greater (e.g. maximum) width adjacent the top surface 208 as compared to the width of the channel or valley adjacent the bottom surface 212. It has been found that when the maximum width of the valley is too small, and/or the maximum width of the valley is too small, and/or the microstructured surface comprises an excess amount of flat surface area the microstructured surface is also more difficult to clean (e.g. microorganisms and dirt).

Presently described are microstructured surfaces comprising microstructures wherein the maximum width of the valleys is at least 1, 2, 3, or 4 microns and more typically greater than 5, 6, 7, 8, 9, or 10 microns ranging up to 250 microns. In some embodiments, the maximum width of the valleys is at least 11, 12, 13, 14, 15, 16, 17, 18, 19, 20, 21, 22, 23, 24, or 25 microns. In some embodiments, the maximum width of the valleys is at least 30, 35, 40, 45, or 50 microns. In some embodiments, the maximum width of the valleys is greater than 50 microns. In some embodiments, the maximum width of the valleys is at least 55, 60, 65, 70, 75, 85, 85, 90, 95 or 100 microns. In some embodiments, the maximum width of the valleys is at least 125, 150, 175, 200, 225, or 250 microns. Larger valleys widths may better accommodate the removal of dirt. In some embodiments, the maximum width of the valleys is no greater than 225, 200, 175, 150, 125, 100, 75, or 50 microns. In some embodiments, the maximum width of the valleys is no greater than 45, 40, 35, 30, 25, 20, or 15 microns. It is appreciated that the microstructured surface would be beneficial even when some of the valleys are less than the maximum width. For example, if half of the valleys are within the desired range, about half the benefit may be obtained. Thus, in some embodiments, less than 50, 45, 40, 35, 30, 25, 20, 15, 10, 5 or 1% of the peak structures have a cross section dimensional at the base of less than 10, 9, 8, 7, 6, or 5 microns. Alternatively, at least 50, 60, 70, 80, 90, 95 or 99% of the valleys have a maximum width, as described above.

In typical embodiments, the maximum width of the microstructures falls within the same ranges as described for the valleys. In other embodiments, the width of the valleys can be greater than the width of the microstructures. Thus, in some favored embodiments, the microstructured surface is typically substantially free of microstructures having a width less than 5, 4, 3, 2, or 1 micron, inclusive of nanostructures having a width less than 1 micron. Some examples of microstructured surfaces that further comprise nanostructures are described in previously cited WO 2012/058605. Nanostructures typically comprise at least one or two dimensions that do not exceed 1 micron (e.g. width and height) and typically one or two dimensions that are less than 1 micron. In some embodiments, all the dimensions of the nanostructures do not exceed 1 micron or are less than 1 micron.

By substantially free, it is meant that there are none of such microstructures present or that some may be present provided that the presence thereof does not detract from the (e.g. cleanability) properties as will subsequently described. Thus, the microstructured surface or microstructures thereof may further comprise nanostructures provided that the microstructured surface provides the technical effects described herein.

The microstructured surface may be present on a second microstructured surface provided the surface provides the technical effect described herein. The second microstructured surface typically have larger microstructures (e.g. having a greater valley width and/or height).

The microstructured surface may be present on a macrostructured surface provided the surface provides the technical effect described herein. A macrostructured surface is typically visible without magnification by a microscope. A macrostructured surface has at least two dimensions (e.g.

length and width) of at least 1 mm. In some embodiments, the average width of a macrostructure is at least 2, 3, 4, 5, 6, 7, 8, 9, or 10 mm. In some embodiments, the average length of a macrostructure can be in the same range as the average width or can be significantly greater than the width. The height of the macrostructure is typically less than the width. In some embodiments, the height is less than 5, 4, 3, 2, 1, or 0.5 mm.

Although smaller structures including nanostructures can prevent biofilm formation, the presence of a significant number of smaller valleys and/or valleys with insufficient side wall angles can impede cleanability including dirt removal. Further, microstructured surfaces with larger microstructures and valleys can typically be manufactured at a faster rate. Thus, in typical embodiments, each of the dimensions of the microstructures is at least 1, 2, 3, 4, 5, 6, 7, 8, 9, 10, 11, 12, 13, 14, or 15 microns or greater than 15 microns as previously described. Further, in some favored embodiments, none of the dimensions of at least 50, 60, 70, 80, 90, 95 or 99% microstructures are less than 15, 14, 13, 12, 11, 10, 9, 8, 7, 6, 5, 4, 3, 2, or 1 micron.

FIG. 9 of PCT Application No. PCT/IB2020/057840 depicts a comparative microstructured surface having discontinuous valleys. Such surface has also been described as having groupings of features arranged with respect to one another as to define a tortuous pathway. Rather, the valleys are intersected by walls forming an array of individual cells, each cell surrounded by walls. Some of the cells are about 3 microns in length; whereas other cells are about 11 microns in length.

In contrast, the valleys of the microstructured surfaces described are substantially free of intersecting side walls or other obstructions to the valley. By substantially free, it is meant that there are no side walls or other obstructions present within the valleys or that some may be present provided that the presence thereof does not detract from the cleanability properties as subsequently described. The valleys are typically continuous in at least one direction. This can facilitate the flow of a cleaning solution through the valley. Thus, the arrangement of peaks typically does not define a tortuous pathway.

The height of the peaks is within the same range as the maximum width of the valleys as previously described. In some embodiments, the peak structures typically have a height (H) ranging from 1 to 125 microns. In some embodiments, the height of the microstructures is at least 2, 3, 4, or 5 microns. In some embodiments, the height of the microstructures is at least 6, 7, 8, 9 or 10 microns. In some embodiments, the height of the microstructures no greater than 100, 90, 80, 70, 60, or 50 microns. In some embodiments, the height of the microstructures is no greater than 45, 40, 35, 30 or 25 microns. In some embodiments, the height of the microstructures is no greater than 24, 23, 22, 21, 20, 19, 18, 17, 16, 15, 14, 13, 12, 11, or 10 microns. In typical embodiments, the height of the valley or channel is within the same range as just described for the peak structures. In some embodiment, the peak structures and valleys have the same height. In other embodiments, the peak structures can vary in height. For example, the microstructured surface may be disposed on a macrostructured or microstructured surface, rather than a planar surface.

The aspect ratio of the valley is the height of the valley (which can be the same as the height of the microstructure) divided by the maximum width of the valley. In some embodiment the aspect ratio of the valley is at least 0.1, 0.15, 0.2, or 0.25. In some embodiments, the aspect ratio of the valley is no greater than 1, 0.9, 0.8, 0.7, 0.6 or 0.5. Thus, the height of the valley is typically no greater than the maximum width of the valley, and more typically less than the maximum width of the valley.

The base of each microstructure may comprise various cross-sectional shapes including but not limited to parallelograms with optionally rounded corners, rectangles, squares, circles, half-circles, half -ellipses, triangles trapezoids, other polygons (e.g. pentagons, hexagons, octagons, etc. and combinations thereof.

In one embodiment, the microstructured surface may have the same surface as a brightness enhancing film. As described for example in U.S. Pat. No. 7,074,463, backlit liquid crystal displays generally include a brightness enhancing film positioned between a diffuser and a liquid crystal display panel. The brightness enhancing film collimates light thereby increasing the brightness of the liquid crystal display panel and also allowing the power of the light source to be reduced. Thus, brightness enhancing films have been utilized as an internal component of an illuminated display devices (e.g. cell phone, computer) that are not exposed to bacteria or dirt.

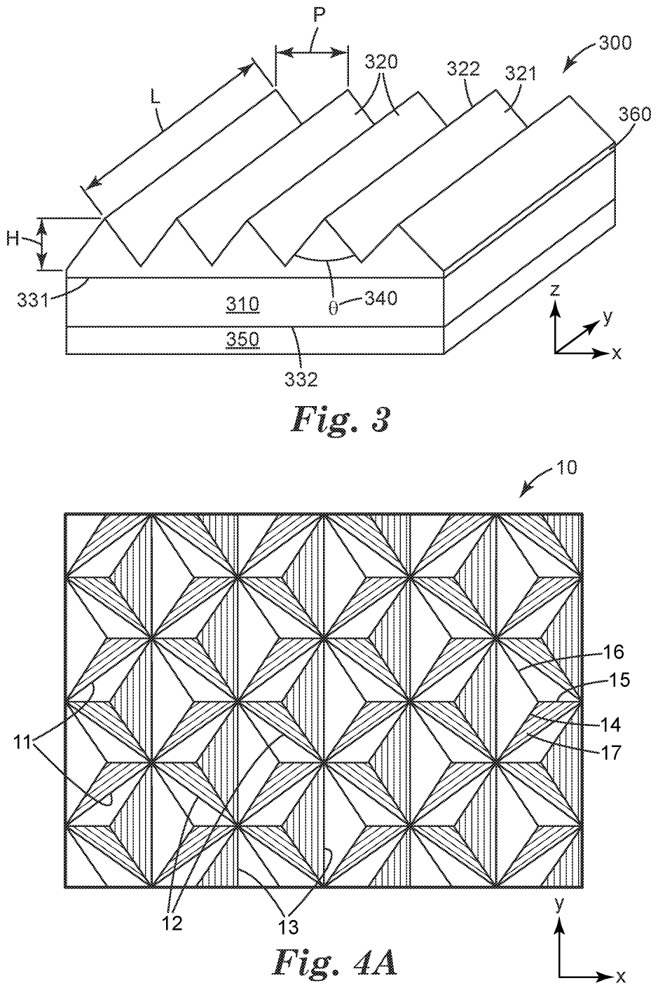

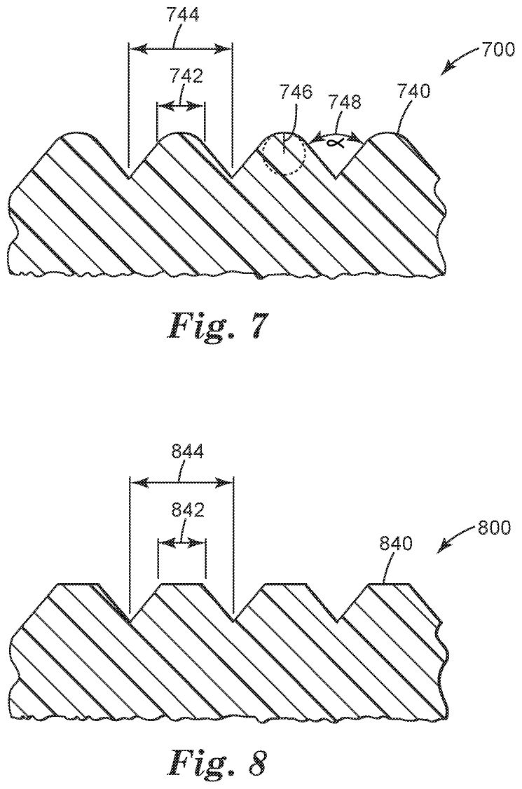

With reference to FIG. 3, in one embodiment, the microstructured surface 300 comprises a linear array of regular right prisms 320. Each prism has a first facet 321 and a second facet 322. The prisms are typically formed on a (e.g. preformed polymeric film) base member 310 that has a first planar surface 331 (parallel to reference plane 126) on which the prisms are formed and a second surface 332 that is substantially flat or planar and opposite first surface. By right prisms it is meant that the apex angle θ, 340, is typically about 90° . However, this angle can range from 70° to 120° and may range from 80° to 100° . In some embodiments, the apex angle can be greater than 60, 65, 70, 75, 80, or 85° . In some embodiments, the apex angle can be less than 150, 145, 140, 135, 130, 125, 120, 110, or 100° . These apexes can be sharp (as shown), rounded (as shown in FIG. 7) or truncated (as shown in FIG. 8). In some embodiments, the included angle of the valley is in the same range as the apex angle. The spacing between prism peaks may be characterized as pitch (“P”). In this embodiment, the pitch is also equal to the maximum width of the valley. Thus, the pitch is greater than 5, 6, 7, 8, 9, or 10 microns ranging up to 250 microns, as previously described. The length (“L”) of the (e.g. prim) microstructures is typically the largest dimension and can span the entire dimension of the microstructured surface, film or article. The prism facets need not be identical and the prisms may be tilted with respect to each other, as shown in FIG. 6. In some embodiments, such as when the microstructured surface is prepared by casting and curing a polymerizable resin, 310 can represent the base member. However, when the microstructured surface is prepared as a film that is adhered to the base member, 350 can represent the base member and 310 can represent an adhesive.

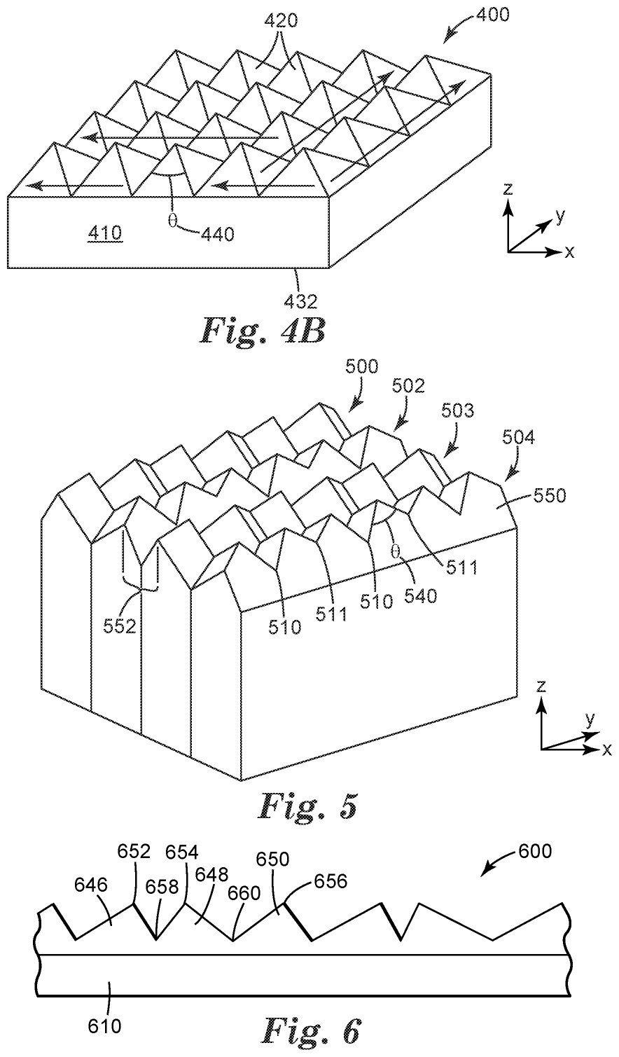

In another embodiment, the microstructured surface may have the same surface as cube corner retroreflective sheeting. Retroreflective materials are characterized by the ability to redirect light incident on the material back toward the originating light source. This property has led to the widespread use of retroreflective sheeting for a variety of traffic and personal safety uses. With reference to FIG. 4A, cube corner retroreflective sheeting typically comprises a thin transparent layer having a substantially planar front surface and a rear structured surface 10 comprising a plurality of cube corner elements 17. A seal film (not shown) is typically applied to the backside of the cube-corner elements; see, for example, U.S. Pat. Nos. 4,025,159 and5,117,304. The seal film maintains an air interface at the backside of the cubes that enables total internal reflection at the interface and inhibits the entry of contaminants such as soil and/or moisture.

The microstructured surface of FIG. 4 may be characterized as an array of cube corner elements 17 defined by three sets of parallel grooves (i.e. valleys) 11, 12, and 13; two sets of grooves (i.e. valleys) intersect each other at an angle greater than 60 degrees and a third set of grooves (valleys) intersects each of the other two sets at an angle less than 60 degrees to form an array of canted cube corner element matched pairs (see U.S. Pat. No. 4,588,258 (Hoopman)). The angles for the grooves are chosen such that the dihedral angle formed at the linear of intersection of the grooves, e.g., 14, 15, and 16 for representative cube-corner element 17 are about 90 degrees.

In another embodiment, depicted in FIG. 4B, the microstructured surface 400 of FIG. 4B may be characterized as an array of pyramidal peak structures 420 defined by a first set of parallel grooves (i.e. valleys) in the y direction and a second set of parallel groves in the x direction. The base of the pyramidal peak structures is a polygon, typically a square or rectangle depending on the spacing of the grooves. The apex angle θ, 440, is typically about 90° . However, this angle can range from 70° to 120° and may range from 80° to 100°.

Other cube corner element structures, described as “full cubes” or “preferred geometry (PG) cube corner elements”, typically comprise at least two non-dihedral edges that are not coplanar as described for example in U.S. Pat. No. 7,188,960; incorporated herein by reference. Full cubes that are not truncated. In one aspect, the base of full cube elements in plain view are not triangular. In another aspect, the non-dihedral edges of full cube elements are characteristically not all in the same plane (i.e. not coplanar). Such cube corner elements may be characterized as “preferred geometry (PG) cube corner elements”.

A PG cube corner element may be defined in the context of a structured surface of cube corner elements that extends along a reference plane. A PG cube corner element means a cube corner element that has at least one non-dihedral edge that: (1) is nonparallel to the reference plane; and (2) is substantially parallel to an adjacent non-dihedral edge of a neighboring cube corner element. A cube corner element with reflective faces that comprise rectangles (inclusive of squares), trapezoids or pentagons are examples of PG cube corner elements.

With reference to FIG. 5, in another embodiment the microstructured surface 500 may comprise an array of preferred geometry (PG) cube corner elements. The illustrative microstructured surface comprises four rows (501, 502, 503, and 504) of preferred geometry (PG) cube corner elements. Each row of preferred geometry (PG) cube corner elements has faces formed from a first and second groove set also referred to as “side grooves”. Such side grooves range from being nominally parallel to non-parallel to within 1 degree to adjacent side grooves. Such side grooves are typically perpendicular to reference plane 124 of FIG. 1. The third face of such cube corner elements preferably comprises a primary groove face 550. This primary groove face ranges from being nominally perpendicular to non-perpendicular within 1 degree to the face formed from the side grooves. In some embodiments, the side grooves can form an apex angle θ, of nominally 90 degrees. In other embodiments, the row of preferred geometry (PG) cube corner elements comprises peak structures formed from an alternating pair of side grooves 510 and 511 (e.g. about 75 and about 105 degrees) as depicted in FIG. 5. Thus, the apex angle 540 of adjacent (PG) cube corner elements can be greater than or less than 90 degrees. In some embodiments, the average apex angle of adjacent (PG) cube corner elements in the same row is typically 90 degrees. As described in previously cited U.S. Pat. No. 7,188,960, during the manufacture of a microstructured surface comprising PG cube corner elements, the side grooves can be independently formed on individual lamina (thin plates), each lamina having a single row of such cube corner elements. Pairs of laminae having opposing orientation are positions such that their respective primary groove faces form primary groove 452, thereby minimizing the formation of vertical walls. The lamina can be assembled to form a microstructured surface which is then replicated to form a tool of suitable size.

In some embodiments, all the peak structures have the same apex angle θ. For example, the previously described microstructured surface of FIG. 3 depicts a plurality of prism structures, each having an apex angle θ of 90 degrees. As another example, the previously described microstructured surface of FIG. 4 depicts a plurality of cube corner structures, each having an apex angle θ of 60 degrees. In other embodiments, the peak structures may form apex angles that are not the same. For example, as depicted in FIG. 5, some of the peak structures may have an apex angle greater than 90 degrees and some of the peak structures may have an apex angle less than 90 degrees. In some embodiments, the peak structures of an array of microstructures have peak structures with different apex angles, yet the apex angles average a value ranging from 60 to 120 degrees. In some embodiments, the average apex angle is at least 65, 70, 75, 80, or 85 degrees. In some embodiments, the average apex angle is less than 115, 110, 100, or 95 degrees.

As yet another example, as depicted in the cross-section of FIG. 6, the microstructured surface 600 may comprise a plurality of peak structures such as 646, 648, and 650 having peaks 652, 654, and 656, respectively. When the microstructured surface is free of flat surfaces, (i.e. surfaces that are parallel to reference plane 126 of FIG. 1), the facets of adjacent peak structures may also define valley. In some embodiments, the facets of the peak structure form a valley with a valley angle of less than 90 degrees (e.g. valley 658). In some embodiments, the facets of the peak structure form a valley with a valley angle of greater than 90 degrees (e.g. valley 660).

FIG. 7 shows another embodiment of a microstructured surface 700, wherein the peak structures have rounded apexes 740. These peak structures are characterized by a chord width 742, a cross-sectional base peak width 744, radius of curvature 746, and root angle 748. In some embodiments, the chord width is equal to about 20% to 40% of the cross-sectional pitch width. In some embodiments, the radius of curvature is equal to about 20% to 50% of the cross-sectional pitch width. In some embodiments, the root angle is at least 50, 65, 70, 80 or 85 degrees. In some embodiments, the root angle is no greater than 110, 105, 100, or 95 degrees. In some embodiments, root angle is at least 60, 65, 70, 75, 80, or 90 degrees can be preferred. The root angle can be the same as the valley angle. In some embodiments, the peak structures have apexes that are rounded to a radius in a range of at least 2, 3, or 4 and no greater than 15, 10, or 5 micrometers. In some embodiments, the valleys are rounded to a radius in a range of at least 2, 3, or 4 and no greater than 15, 10, or 5 micrometers. In some embodiments, both the peaks and valleys are rounded to a radius in a range of at least 2, 3, or 4 and no greater than 15, 10, or 5 micrometers.

FIG. 8 shows another embodiment of a microstructured surface 800, wherein the peak structures 840 are truncated, having flat or in other words planar top surface (parallel to reference plane 126 of FIG. 1). These peak structures can be are characterized by a flattened width 842 and cross-sectional base peak width 844. In typical embodiments, the flattened width can be equal to or less than 50, 45, 40, 35, 30, 25, 20, 15, 10, 5, 4, 3, 2, or 1% of the cross-sectional base peak width. Notably, a peak structure can have the same side wall angle regardless of whether the apex is sharp, rounded, or truncated.

In some embodiments, the peak structures typically comprises at least two (e.g. prisms of FIG. 3), three (e.g. cube corners of FIG. 4) or more facets. For example, when the base of the microstructure is an octagon the peak structures comprise eight side wall facets. However, when the facets have rounded or truncated surfaces, such as shown in FIGS. 7-8; the microstructures may not be characterized by a specific geometric shape.

When the facets of the microstructures are joined such that the apex and valleys are sharp or rounded, but not truncated, the microstructured surface can be characterized are being free of flat surfaces, that are parallel to the planar base layer. However, wherein the apex and/or valleys are truncated, the microstructured surface typically comprises less than 50, 45, 40, 35, 30, 25, 20, 15, 10, 5 or 1% of flat surface area that is parallel to the planar base layer.

In each of the embodiments of FIGS. 3-8, the facets of adjacent (e.g. prism or cube corner) peak structures are typically connected at the bottom of the valley, i.e. proximate the planar base layer. The facets of the peak structures form a continuous surface in the same direction. For example, in FIG. 3, the facets 321 and 322 of the (e.g. prism) peak structures are continuous in the direction of the length (L) of the microstructures or in other words, the y-direction. As yet another example, the primary grooves 452 and 550 of the PG curb corner elements of FIG. 5 form a continuous surface in the y-direction. In other embodiments, the facets form a semi-continuous surface in the same direction. For example, in FIG. 4, facets of the (e.g. cube corner or pyramidal) peak structures are in the same plane in both the x- and y-directions. These semi-continuous and continuous surfaces can assist in the cleaning of pathogens from the surface.

In some embodiments, the apex angle of the peak structure is typically two times the wall angle, particularly when the facets of the peak structures are interconnected at the valleys between peak structures. Thus, the apex angle is typically greater than 20 degrees and more typically at least 25, 30, 35, 40, 45, 50, 55, or 60 degrees. The apex angle of the peak structure is typically less than 160 degrees and more typically less than 155, 150, 145, 140, 135, 130, 125 or 120 degrees.

Topography maps were obtained using confocal laser scanning microscopy (CLSM). The CLSM instrument used for all imaging is a Keyence VK-X200. CLSM is an optical microscopy technique that scans the surface using a focused laser beam to map the topography of a surface. CLSM works by passing a laser bean through a light source aperture which is then focused by an objective lens into a small area on the surface and image is built up pixel-by-pixel by collecting the emitted photons from the sample. It uses a pinhole to block out-of-focus light in image formation. Dimensional analysis was used to measure various parameters using SPIP 6.7.7 image metrology software according to the manual (see https://www.imagenet.com/media-library/support-documents).

Surface roughness parameters, Sa (Roughness Average), Sq (Root Mean Square), and Sbi (Surface Bearing Index), Svi (Valley Fluid Retention Index) were calculated from the topographic images (3D). Prior to calculating roughness, a plane correction was used “Subtract Plane” (1^{st} order planefit form removal).

The S parameters of some representative examples and comparative examples are described in 82346WO; incorporated herein by reference.

The Roughness Average, Sa, is defined as:

$${S}_{a} = \frac{1}{MN} {\sum }_{k = 0}^{M - 1} {\sum }_{l = 0}^{N - 1} \vert z ( {ϰ}_{k} , {y}_{l} ) \vert$$

where M and N are the number of data points X and Y.

Although smooth surfaces can have a Sa approaching zero, the comparative smooth surfaces that were found to have poor microorganism removal after cleaning had an average surface roughness, Sa, of at least 10, 15, 20, 25 or 30 nm. The average surface roughness, Sa, of the comparative smooth surfaces was less than 1000 nm (1 micron). In some embodiments, Sa of the comparative smooth surface was at least 50, 75, 100, 125, 150, 200, 250, 300, or 350 nm. In some embodiments, Sa of the comparative smooth surface was no greater than 900, 800, 700, 600, 500, or 400 nm.

The average surface roughness, Sa, of the microstructured surfaces having improved microorganism removal after cleaning was 1 micron (1000 nm) or greater. In some embodiments,

Sa was at least 1100 nm, 1200 nm, 1300 nm, 1400 nm, 1500 nm, 1600 nm, 1700 nm, 1800 nm, 1900 nm, or 2000 nm (2 microns). In some embodiments, Sa of the microstructured surfaces was at least 2500 nm, 3000 nm, 3500 nm, 4000 nm or 5000 nm. In some embodiments, Sa of the microstructured surfaces was at least 10,000 nm, 15,000 nm, 20,000 nm or 25,000 nm. In some embodiments, Sa of the microstructured surfaces having improved microorganism removal after cleaning was no greater than 40,000 nm (40 microns), 35,000 nm, 30,000 nm, 15,000 nm, 10,000 nm, or 5,000 nm.

In some embodiments, Sa of the microstructured surface is at least 2 or 3 times the Sa of a smooth surface. In other embodiments, Sa of the microstructured surface is at least 4, 5, 6, 7, 8, 9, or 10 times the Sa of a smooth surface. In other embodiments, Sa of the microstructured surface is at least 15, 20, 25, 30, 35, 40, 45, 50 times the Sa of a smooth surface. In other embodiments, Sa of the microstructured surface is at least 100, 200, 300, 400, 500, 600, 700, 800, 900, or 1000 times the Sa of a smooth surface.

The Root Mean: Square (RMS) parameter Sq, is defined atL

$${S}_{q} = \sqrt{\frac{1}{MN} {\sum }_{k = 0}^{M - 1} {\sum }_{l = 0}^{N - 1} {[ z ( {ϰ}_{k} , {y}_{l} ) ]}^{2}}$$

where M and N are the number of data points X and Y.

Although the Sq values are slightly higher than the Sa values, the Sq values also fall within the same ranges just described for the Sa values.

The Surface Bearing Index, Sbi is defined at:

$${S}_{bi} = \frac{{S}_{q}}{{Z}_{0.05}} ,$$

wherein Z_{0.05} is the surface height at 5% bearing area.

The Valley Fluid Retention Index, Svi is defined as:

$${S}_{vi} = \frac{{V}_{i} ( {h}_{0.80} )}{( M - 1 ) ( N - 1 ) δ ϰδ y} / {S}_{q} ,$$

wherein Vv(h0.80) is the void volume at valley zone within 80-100% bearing area.

The Sbi/Svi ratio of comparative smooth samples were 1 and 3. The microstructured surfaces having improved microorganism removal after cleaning had a Sbi/Svi ratio of greater than 3. The microstructured surfaces have a Sbi/Svi ratio of at least 4, 5, or 6. In some embodiments, the microstructured surfaces having improved microorganism removal after cleaning had a Sbi/Svi ratio of at least 7, 8, 9, or 10. In some embodiments, the microstructured surfaces having improved microorganism removal after cleaning had a Sbi/Svi ratio of at least 15, 20, 25, 30, 35, 40 or 45. The microstructured surfaces having improved microorganism removal after cleaning had a Sbi/Svi ratio of less than the comparative square wave microstructured surfaces. Thus, the microstructured surfaces having improved microorganism removal after cleaning had a Sbi/Svi ratio of less than 90, 85, 80, 75, 70 or 65. In some embodiments, the microstructured surfaces having improved microorganism removal after cleaning had a Sbi/Svi ratio of less than 60, 55, 50, 45, 40, 35, 30, 25, 20, or 10.

Topography maps can also be used to measure other features of the microstructured surface. For example, the peak height (especially of a repeating peak of the same height) can be determined from the height histogram function of the software. To calculate the percentage of “flat regions” of a square wave film, the “flat regions” can be identified using SPIP's Particle Pore Analysis feature, which identifies certain shapes (in this case, the “flat tops” of the microstructured square wave film

### Materials

In some embodiments, the peak structures and (e.g., planar) base member comprise a different material. For example, as described in Lu et al., U.S. Pat. No. 5,175,030, and Lu, U.S. Pat. No. 5,183,597, a microstructure-bearing article (e.g. brightness enhancing film) can be prepared by a method including the steps of (a) preparing a polymerizable composition; (b) depositing the polymerizable composition onto a master negative microstructured molding surface in an amount barely sufficient to fill the cavities of the master; (c) filling the cavities by moving a bead of the polymerizable composition between a preformed base (such as a PET film) and the master, at least one of which is flexible; and (d) curing the composition. The master can be metallic, such as nickel, nickel-plated copper or brass, or can be a thermoplastic material that is stable under the polymerization conditions, and that preferably has a surface energy that allows clean removal of the polymerized material from the master. One or more the surfaces of the base film can optionally be primed or otherwise be treated to promote adhesion of the optical layer to the base.

Such casting and curing method can be utilized to form a thermoformable microstructured base member (e.g. sheet or plate).

In many embodiments, the base member (e.g., thermoformable) may be a polymeric material that may include, for example, one or more of amorphous thermoplastic polymers, semi-crystalline thermoplastic polymers and transparent thermoplastic polymers such as polycarbonate, thermoplastic polyurethane, acrylic, polysulfone, polypropylene, polypropylene/ethylene copolymer, cyclic olefin polymer/copolymer, poly-4-methyl-1-pentene or polyester/polycarbonate copolymer, styrenic polymeric materials, polyamide, polymethylpentene, polyetheretherketone and combinations thereof. In another embodiment, the base member may be chosen from clear or substantially transparent semi-crystalline thermoplastic, crystalline thermoplastics and composites, such as polyamide, polyethylene terephthalate. polybutylene terephthalate, polyester/polycarbonate copolymer, polyolefin, cyclic olefin polymer, styrenic copolymer, polyetherimide, polyetheretherketone, polyethersulfone, polytrimethylene terephthalate, and mixtures and combinations thereof In some embodiments, base member is a polymeric material chosen from polyethylene terephthalate, polyethylene terephthalate glycol, polycyclohexylenedimethylene terephthalate glycol, and mixtures and combinations thereof. One example of a commercially available material suitable as the elastic polymeric material for the base member 902, which is not intended to be limiting, is polyethylene terephtbalate (polyester with glycol additive (PETg)). Suitable PETg resins can be obtained from various commercial suppliers such as, for example, Eastman Chemical, Kingsport, Tenn.; SK Chemicals, Irvine, Calif.; DowDuPont, Midland, Mich.; Pacur, Oshkosh, Wis.; and Scheu Dental Tech, Iserlohn, Germany.

In some embodiments, the base member (e.g., base member 902) may be made of a single polymeric material or may include multiple layers of different polymeric materials.

In one embodiment, a method of making a medical article is described comprising providing a base member (e.g. sheet or plate) comprising a microstructured surface. The base member comprises a thermoplastic of thermosettable material. The peak structures comprise a different material than the base member such that the peak structures have a melt temperature greater than the base member. The peak structures typically comprise a cured polymerizable resin. The method comprises thermoforming the microstructured base member (e.g. film, sheet or plate) into an article at a temperature below the melt temperature of the peak structures.

Useful base member materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, polyimides, and glass. Optionally, the (e.g., planar) base member material can contain mixtures or combinations of these materials. In an embodiment, the base may be multi-layered or may contain a dispersed component suspended or dispersed in a continuous phase. An examples of a useful PET films include photograde polyethylene terephthalate and MELINEX™ PET available from DuPont Films of Wilmington, Del. An example of a useful thermoformable material is VIVAK PETG. Such material is characterized by having a tensile strength ranging from 5000-10,000 psi (ASTM D638) and a flexural strength of 5,000 to 15,000 (ASTM D-790). Such material has a glass transition temperature of 178° F. (ASTM D-3418).

Various polymerizable resins have been described that are suitable for the manufacture of microstructured films. In typical embodiments, the polymerizable resin comprises at least one (meth)acrylate monomer or oligomer comprising at least two (meth)acrylate groups (e.g., Photomer 6210), (e.g., multi(meth)acrylate, and a crosslinker (e.g., HDDA).

The materials for retroreflective sheeting and brightness enhancing films has been chosen based on the optical properties. Thus, the peak structures and adjacent valleys comprise a material having a refractive index of at least 1.50, 1.55, 1.60 or greater. Further, the transmission of visible light is typically greater than 85 or 90%. However, optical properties may not be of concern for many embodiments of the presently described methods and medical articles. Thus, various other materials may be used having a lower refractive index including colored and opaque.

As shown in FIG. 3, a continuous land layer 340 can be present between the bottom of the channels or valleys and the top surface 331 of (e.g., planar) base member 310. In some embodiments, such as when the microstructured surface is prepared from casting and curing a polymerizable resin composition, the thickness of the land layer can be lower. For example, the thickness of the land layer is typically at least 0.5, 1, 2, 3, 4, or 5 microns ranging up to 50 microns. In some embodiments, the thickness of the land layer is no greater than 45, 40, 35, 30, 25, 20, 15, or 10 microns.

In some embodiments, the microstructured surface (e.g. at least peak structures thereof) comprise an organic polymeric material with a glass transition temperature (as measured with Differential Scanning calorimetry) of at least 25° C. In some embodiments, the organic polymeric material has a glass transition temperature of at least 30, 35, 40, 45, 50, 55, or 60° C. In some embodiments, the organic polymeric material has a glass transition temperature no greater than 100, 95, 90, 85, 80, or 75° C. For example polycarbonate is reported to have a Tg of 145° C.

In other embodiments, the microstructured surface (e.g. at least peak structure thereof) comprises an organic polymeric material with a glass transition temperature as measured with Differential Scanning calorimetry of less than 25° C. or less than 10° C. In at least some embodiments, the microstructures may be an elastomer. An elastomer may be understood as a polymer with the property of viscoelasticity (or elasticity) generally having suitably low Young's modulus and high yield strain as compared with other materials. The term is often used interchangeably with the term rubber, although the latter is preferred when referring to crosslinked polymers.

The organic polymeric material may also be filled with suitable organic or inorganic fillers and for certain applications the fillers are radioopaque.

In one embodiment, the microstructures may be made of a curable, thermoset material. Unlike thermoplastic materials wherein melting and solidifying is thermally reversible; thermoset plastics cure after heating and therefore although initially thermoplastic, either cannot be remelted after curing or the melt temperature is significantly higher after being cured. In some embodiments, the thermoset material includes a majority of silicone polymer by weight. In at least some embodiments, the silicone polymer will be polydialkoxysiloxane such as poly(dimethylsiloxane) (PDMS), such that the microstructures are made of a material that is a majority PDMS by weight. More specifically, the microstructures may be all or substantially all PDMS. For example, the microstructures may each be over 95wt. % PDMS. In certain embodiments the PDMS is a cured thermoset composition formed by the hydrosilylation of silicone hydride (Si—H) functional PDMS with unsaturated functional PDMS such as vinyl functional PDMS. The Si—H and unsaturated groups may be terminal, pendant, or both. In other embodiments the PDMS can be moisture curable such as alkoxysilane terminated PDMS. In some embodiments, other silicone polymers besides PDMS may be useful, for example, silicones in which some of the silicon atoms have other groups that may be aryl, for example phenyl, alkyl, for example ethyl, propyl, butyl or octyl, fluoroalkyl, for example 3,3,3-trifluoropropyl, or arylalkyl, for example 2-phenylpropyl. The silicone polymers may also contain reactive groups, such as vinyl, silicon-hydride (Si—H), silanol (Si—OH), acrylate, methacrylate, epoxy, isocyanate, anhydride, mercapto and chloroalkyl. These silicones may be thermoplastic or they may be cured, for example, by condensation cure, addition cure of vinyl and Si—H groups, or by free-radical cure of pendant acrylate groups. They may also be cross-linked with the use of peroxides. Such curing may be accomplished with the addition of heat or actinic radiation.

Other useful polymers may be thermoplastic or thermoset and include polyurethanes, polyolefins including metallocene polyolefins, polyesters such as elastomeric polyesters (e.g., Hytrel), biodegradable polyesters such as polylactic, polylactic/glycolic acids, copolymers of succinic acid and diols, and the like, fluoropolymers including fluoroelastomers, polyacrylates and polymethacrylates. Polyurethanes may be linear and thermoplastic or thermoset. Polyurethanes may be formed from aromatic or aliphatic isocyanates combined with polyester or polyether polyols or a combination thereof.

The organic polymeric material of the microstructured surface may contain other additives such as antimicrobial agents (including antiseptics and antibiotics), dyes, mold release agents, antioxidants, plasticizers, and the like. Suitable antimicrobials can be incorporated into or deposited onto the polymers. Suitable preferred antimicrobials include those described in US Publication Nos. 2005/0089539 and 2006/0051384 to Scholz et al. and US Publication Nos. 2006/0052452 and 2006/0051385 to Scholz. The microstructures of the present invention also may be coated with antimicrobial coatings such as those disclosed in International Application No. PCT/US2011/37966 to Ali et al.

In typical embodiments, the microstructured surface is not prepared from a (e.g. fluorinated (e.g. fluoropolymer) or PDMS) low surface energy material and does not comprise a low surface energy coating, a material or coating that on a flat surface has a receding contact angle with water of greater than 90, 95, 100, 105, or 110 degrees. In this embodiment, the low surface energy of the material is not contributing to the cleanability. Rather, the improvement in cleaning is attributed to the features of the microstructured surface.

In some embodiments, a surface energy modifying coating may be applied to the microstructures. A low surface energy coating may generally be characterized as a coating that, on a flat surface, has a water contact angle of greater than 110 degrees. The presence of such coating, may further enhance the cleanability. Exemplary low surface energy coating materials that may be used include materials such as hexafluoropropylene oxide (HFPO), or organosilanes such as, alkylsilane, alkoxysilane, acrylsilanes, polyhedral oligomeric silsesquioxane (POSS) and fluorine-containing organosilanes, just to name a few. Examples of particular coatings known in the art may be found, e.g., in US Publication No. 2008/0090010, and commonly owned publication, US Publication No. 2007/0298216. For embodiments, that include a coating is applied to the microstructures, it may be applied by any appropriate coating method, such as sputtering, vapor deposition, spin coating, dip coating, roll-to-roll coating, or any other number of suitable methods.

It also is possible and often preferable in order to maintain the fidelity of the microstructures to include a surface energy modifying compound in the composition used to form the microstructures. In some embodiments, the bloom additive may retard or prevent crystallization of the base composition. Suitable bloom additives may be found, for example, in International Publication No. WO2009/152345 to Scholz et al. and U.S. Pat. No. 7,879,746 to Klun et al.

Referring again to FIGS. 2-4 and 6, the presently described articles comprise an (e.g. engineered) microstructured surface (200, 300, 400, 600) disposed on a base member (210, 310, 410, 610). The thickness of the base member is typically at least 10, 15, 20, or 25 microns (1 mil) and typically no greater than 500 microns (20 mil) thickness. In some embodiments, the thickness of the base member is no greater than 400, 300, 200, or 100 microns. Thermoformable microstructured base members may have thickness up to 3, 4, or 5 mm or greater. The width of the base member may be at least 30 inches (122 cm) and preferably at least 48 inches (76 cm).

The base member may be planar or non-planar, having a curved surface or a surface with a complex topography.

The base member can be formed from various materials such as metal, alloy, organic polymeric material, or a combination comprising at least one of the foregoing. Specifically, glass, ceramic, metal or polymeric material may be appropriate, as well as other suitable alternatives and combinations thereof such as ceramic coated polymers, ceramic coated metals, polymer coated metals, metal coated polymers and the like. The base member can, in some implementations, include discrete pores and/or pores in communication. The thickness of the substrate can vary depending on the use.

The organic polymeric materials of the base member can be the same organic polymeric materials (e.g., thermoplastic, thermoset) previously described for the microstructured surface. In addition, fiber- and/or particle-reinforced polymers can also be used. Non-limiting examples of suitable non-biodegradable polymers include polyisobutylene copolymers and styrene-isobutylene-styrene block copolymers, such as styrene-isobutylene-styrene tert-block copolymers (SIBS); polyvinylpyrrolidone including cross-linked polyvinylpyrrolidone; polyvinyl alcohols; copolymers of vinyl monomers such as EVA; polyvinyl ethers; polyvinyl aromatics; polyethylene oxides; polyesters such as polyethylene terephthalate; polyamides; polyacrylamides; polyethers such as polyether sulfone; polyolefins such as polypropylene, polyethylene, highly crosslinked polyethylene, and high or ultra-high molecular weight polyethylene; polyurethanes; polycarbonates; silicones; siloxane polymers; natural based polymers such as optionally modified polysaccharides and proteins including, but not limited to, cellulosic polymers and cellulose esters such as cellulose acetate; and combinations comprising at least one of the foregoing polymers. Combinations may include miscible and immiscible blends as well as laminates.

The base member may be comprised of a biodegradable material. Non-limiting examples of suitable biodegradable polymers include polycarboxylic acid; polyanhydrides such as maleic anhydride polymers; polyorthoesters; poly-amino acids; polyethylene oxide; polyphosphazenes; polylactic acid, polyglycolic acid, and copolymers and mixtures thereof such as poly(L-lactic acid) (PLLA), poly(D,L,-lactide), poly(lactic acid-co-glycolic acid), and 50/50 weight ratio (D,L-lactide-co-glycolide); polydioxanone; polypropylene fumarate; polydepsipeptides; polycaprolactone and co-polymers and mixtures thereof such as poly(D,L-lactide-co-caprolactone) and polycaprolactone co-butylacrylate; polyhydroxybutyrate valerate and mixtures thereof; polycarbonates such as tyrosine-derived polycarbonates and acrylates, polyiminocarbonates, and polydimethyltrimethylcarbonates; cyanoacrylate; calcium phosphates; polyglycosaminoglycans; macromolecules such as polysaccharides (including hyaluronic acid, cellulose, and hydroxypropylmethyl cellulose; gelatin; starches; dextrans; and alginates and derivatives thereof, proteins and polypeptides; and mixtures and copolymers of any of the foregoing. The biodegradable polymer can also be a surface erodible polymer such as polyhydroxybutyrate and its copolymers, polycaprolactone, polyanhydrides (both crystalline and amorphous), and maleic anhydride.

In some embodiments, the microstructured surface may be provided on the base member by coating, injection molding, embossing, laser etching, extrusion, or casting and curing a polymerizable.

Injection molding into a mold wherein the mold comprises a negative replication of the microstructured surface is particularly suitable for three-dimensional articles.

In some embodiments, the (e.g. engineered) microstructured surface may be provided as a film and affixed to the base member. In such embodiments, the microstructure surfaces may be made of the same or different material as the base member. Fixation may be provided using mechanical coupling, an adhesive, a primer, a thermal process such as heat welding, ultrasonic welding, RF welding and the like, or a combination thereof.

The base member may be subjected to customary surface treatments for better adhesion with the adjacent adhesive layer. Additionally, the base member may be subjected to customary surface treatments for better adhesion of the (e.g., cast and cured) microstructured layer to an underlying base member. Surface treatments include for example exposure to ozone, exposure to flame, exposure to a high-voltage electric shock, treatment with ionizing radiation, and other chemical or physical oxidation treatments. Chemical surface treatments include primers. Examples of suitable primers include chlorinated polyolefins, polyamides, and modified polymers disclosed in U.S. Pat. Nos. 5,677,376, 5,623,010 and those disclosed in WO 98/15601 and WO 99/03907, and other modified acrylic polymers. In one embodiment, the primer is an organic solvent based primer comprising acrylate polymer, chlorinated polyolefin, and epoxy resin as available from 3M Company as “3M™ Primer 94”.

Advantages of this invention are further illustrated by the following examples, but the particular materials and amounts thereof recited in these examples, as well as other conditions and details, should not be construed to unduly limit this invention. Unless otherwise indicated, all parts and percentages are by weight.

### EXAMPLES

### Materials

| Abbreviation | Description and Source |
|---|---|
| TWEEN 20 | Polyethylene glycol sorbitan monolaurate non-ionic detergent |
| | (Sigma-Aldrich Company, St. Louis, MO |
| PBS | Phosphate buffered saline (Thermo Fischer Scientific, Waltham, MA) |
| D/E neutralizing | Dey/Engley neutralizing broth (Becton, Dickinson and Company, |
| broth | Franklin Lakes, NJ) |
| MELINEX 618 | MELINEX 618 PET film (DuPont Teijin Films, Chester, VA) |
| SONTARA 8000 | Polyethylene terephthalate (PET) nonwoven sheet (12 micron fiber |
| | diameter, 40 gsm) (Jacob Holm Group, Basel, Switzerland) |
| DURAN PET-G | Polyethylene terephthalate glycol disc (clear, transparent) (Scheu Dental |
| | GmbH, Iserlohn, Germany) |
| VIVAK PET-G | Polyethylene terephthalate glycol sheet (Plaskolite Incorporated, |
| | Columbus, OH) |
| PHOTOMER 6210 | Aliphatic urethane diacrylate oligomer (IGM Resins, Charlotte, NC) |
| SR238 | 1,6-Hexanediol diacrylate, obtained from Satomer, Exton, PA |
| LUCIRIN TPO | Photoinitiator (BASF Corporation, Florham Park, NJ) |
| DAROCUR 1173 | Photoinitiator (BASF Corporation) |
| IRGACURE-651 | Photoinitiator (BASF Corporation) |

### Methods

### Scanning Electron Microscopy—Sample Preparation and Imaging

Sample discs were fixed for scanning electron microscopy (SEM) by carefully submerging each disc in a 5% glutaraldehyde solution for 30 minutes. This was followed by six sequential disc submersion wash steps (submersion time of 30 minutes for each wash step) performed in the following order: 1) a PBS solution, 2) an aqueous 25% isopropyl alcohol solution, 3) an aqueous 50% isopropyl alcohol solution, 4) an aqueous 75% isopropyl alcohol solution, 5-6) two final submersion washes in a 100% isopropyl alcohol solution. Each disc was transferred to a 96-well plate using tweezers. The discs were allowed to dry for 48 hours. Discs were then individually affixed to a SEM stub using double sided tape with the microstructured surface of the disc facing outward from the stub. Conductive silver paint was dabbed on the edge of each sample and the whole stub assembly was sputter coated for 90 seconds using a Denton Vacuum Desk V Sputter Coater (Denton Vacuum, Moorestown, N.J.) and a gold target. After sputter coating, the stub was moved to a JEOL JCM-500 NeoScope SEM instrument (JEOL USA Incorporated, Peabody, Mass.) for imaging.

### Media Preparation

Tryptic Soy Broth (TSB, obtained from Becton, Dickinson and Company, Franklin Lakes, N.J.) was dissolved in deionized water and filter-sterilized according to the manufacturer's instructions.

Brain Heart Infusion (BHI, obtained from Becton, Dickinson and Company) was dissolved in deionized and filter-sterilized according to the manufacturer's instructions.

### Bacterial Cultures

A streak plate of Pseudomonas aeruginosa (ATCC 15442) or Staphylococcus aureus (ATCC 6538) was prepared from a frozen stock on Tryptic Soy Agar. The plate was incubated overnight at 37° C. A single colony from the plate was transferred to 10 mL of sterile TSB. The culture was shaken overnight at 250 revolutions per minute and 37° C. Inoculation samples were prepared by diluting the culture (about 10⁹ colony forming units (cfu)/mL) 1:100 in TSB.

An overnight culture of Streptococcus mutans (ATCC 25175) was grown by using a sterile, serological pipette to scrape and transfer a small amount of a 25% glycerol freezer stock of the microorganism to a 15 mL conical tube. The tube contained 5 mL of BHI broth. The tube was maintained at 37° C. under static (non-shaking) conditions for 12-16 hours. Inoculation samples were prepared by diluting the culture (about 10⁹ colony forming units (cfu)/mL) 1:100 in TSB.

### Procedure for Preparing Microstructured Films

A UV curable resin was prepared from PHOTOMER 6210 aliphatic urethane diacrylate oligomer (75 parts), SR238 1,6-hexanediol diacrylate (25 parts), and LUCIRIN TPO photoinitiator (0.5%). The components were blended in a high-speed mixer, heated in an oven at about 70° C. for 24 hours) and then cooled to room temperature. Copper buttons (2 inch (5.08 cm) diameter) were used as templates for preparing linear prism films. A button and the compounded resin were both heated in an oven at about 70° C. for 15 minutes. Approximately six drops of the warmed resin were applied using a transfer pipette to the center of the warmed button. A section of MELINEX 618 PET support film [3 inch by 4 inch (7.62 cm by 10.16 cm), 5 mil thick] was placed over the applied resin followed by a glass plate. The primed surface of the PET film was oriented to contact the resin. The glass plate was held in place with hand pressure until the resin completely covered the surface of the button. The glass plate was carefully removed. If any air bubbles were introduced, a rubber hand roller was used to remove them.

The sample was cured with UV light by passing the sample 2 times through a UV processor (model QC 120233AN with two Hg vapor lamps, obtained from RPC Industries, Plainfield, Ill.) at a rate of 15.2 meters/minute (50 feet/minute) under a nitrogen atmosphere. The cured, microstructured film having an array pattern of FIG. 3 was removed from the copper template by gently pulling away at a 90° angle. A release liner backed adhesive layer (8 mil thick, obtained as 3M 8188 Optically Clear Adhesive from the 3M Corporation) was applied to the back surface (i.e. non-microstructured surface) of the microstructured film using a hand roller. The features of the linear prism microstructured films that were prepared are reported in Table 1.

TABLE 1

| | | Maximum | | | Side | |
|---|---|---|---|---|---|---|
| | Peak | Valley | Apex | Valley | Wall | Apex |
| | Height | Width | Angle | Angle | Angle | (Radius of |
| Film | (microns) | (microns) | (degrees) | (degrees) | (degrees) | Curvature) |
| Example 1 | 6.6 | 17 | 95 | 95 | 47.5 | sharp |
| Example 2 | 6.0 | 24 | 91 | 91 | 45.5 | sharp |
| Example 3 | 25.0 | 50 | 90 | 90 | 45 | sharp |
| Example 4 | 125 | 250 | 90 | 90 | 45 | sharp |
| Example 5 | 24.2 | 50 | 90 | 90 | 45 | rounded |
| | | | | | | (2 microns) |
| Example 6 | 125 | 250 | 90 | 90 | 45 | rounded |
| | | | | | | (2 microns) |
| Example 7 | 124.2 | 50 | 90 | 90 | 45 | rounded |
| | | | | | | (8.5 microns) |
| Example 8 | 121.5 | 250 | 90 | 90 | 45 | rounded |
| | | | | | | (8.5 microns) |

### Comparative Example A

Comparative Example A film was prepared according to the same procedure as described above with the exception that a copper button having a smooth surface for contacting the resin was used instead of a patterned microstructured surface. This resulted in the formation of a film having a smooth surface (i.e. a film without a patterned, microstructured surface).

### Sample Disc Preparation

A 34 mm diameter hollow punch was used to cut out individual discs from the microstructured films. A single disc was placed in each well of a sterile 6-well microplate and oriented so that the microstructured surface of the disc faced the well opening and the release liner faced the well bottom. The plate was then sprayed with a mist of isopropyl alcohol to disinfect the samples and allowed to dry. Discs were also prepared from the Comparative Example A film.

### Sample Disc Inoculation, Incubation and Washing Method

Inoculation samples (4 mL) of a bacterial culture (described above) were added to each well of the 6-well microplate containing a disc. The lid was placed on the 6-well microplate and the plate was wrapped in PARAFILM M laboratory film (obtained from the Bemis Company, Oshkosh, Wis.). The wrapped plate was inserted in a plastic bag containing a wet paper towel and the sealed bag was placed in an incubator at 37° C. After 7 hours, the plate was removed from the incubator and the liquid media was removed from each well using a pipette. Fresh, sterile TSB (4 mL) was added to each well and the plate lid was attached. The plate was re-wrapped in PARAFILM M laboratory film, sealed in a bag with a wet paper towel, and returned to the incubator. After 17 hours, the plate was removed from the incubator. The liquid media was removed from each well (using a pipette) and replaced with 4 mL of sterile, deionized water. The water was removed and replaced with 4 mL portions of sterile, deionized water two additional times. The final water portion was removed from each well and then the discs were removed. The liner layer was peeled from each disc to expose the adhesive backing. Smaller 12.7 mm diameter discs were cut from each disc using a hollow punch. Some of the discs (n=3) were analyzed for colony count (cfu) on the disc and some of the discs (n=3) were carried on to the cleaning procedure step.

### Sample Disc Cleaning Procedure A

The 12.7 mm diameter disc was attached through the adhesive backing of the disc to a cleaning lane of an Elcometer Model 1720 Abrasion and Washability Tester (Elcometer Incorporated, Warren, Mich.). Unless otherwise specified, each disc was placed in the tester so that the microstructured channels in the disc surface were oriented in the same direction as the cleaning carriage motion. A 2 inch by 5 inch (5.08 cm by 12.7 cm) section of a nonwoven sheet [selected from either SONTARA 8000 or a polypropylene nonwoven sheet (5.9 micron fiber diameter, 40 gsm)] was soaked in solution containing TWEEN 20 (0.05%) in deionized water and excess liquid was squeezed out. The nonwoven sheet was secured around the Universal Material Clamp Tool (450 g) and the tool was attached to the carriage of the instrument. The instrument was set to operate with 15 carriage cycles at a rate of 60 cycles/minute (total cleaning time =15 seconds).

### Sample Disc Cleaning Procedure B

The 12.7 mm diameter disc was attached through the adhesive backing of the disc to a cleaning lane of an Elcometer Model 1720 Abrasion and Washability Tester. Unless otherwise specified, each disc was placed in the tester so that the microstructured channels in the disc surface were oriented in the same direction as the cleaning carriage motion. A tool was prepared by additive manufacturing to hold the head of an Acclean manual toothbrush (average bristle diameter about 180 microns, obtained from Henry Schein Incorporated, Melville, N.Y.) in the carriage of the instrument. The toothbrush head and the disc were aligned so that the entire exposed surface of the disc was contacted by the bristles of the brush. The brush bristles were soaked in water prior to operation. The instrument was set to operate with 15 carriage cycles at a rate of 60 cycles/minute (total cleaning time =15 seconds). The weight of the tool was 190 g.

### Sample Disc Colony Count Method A

Following the cleaning procedure, each disc was washed five times with 1 mL portions of a solution containing TWEEN 20 (0.05%) in PBS buffer. Each washed disc was individually transferred to a separate 50 mL conical vial that contained a solution of TWEEN 20 (0.05%) in PBS buffer (10 mL). Each tube was sequentially vortexed for 1 minute, sonicated for 1 minute using a Branson 2510 Ultrasonic Cleaning Bath (Branson Ultrasonics, Danbury, Conn.), and vortexed for 1 minute. The solution from each tube was serially diluted (about 8 dilutions) with Butterfield's buffer (obtained from the 3M Corporation) to yield a bacterial concentration level that provided counts of colony forming units (cfu) within the counting range of a 3M PETRIFILM Aerobic Count Plate (3M Corporation). An aliquot (1 mL) from each diluted sample was plated on a separate 3M PETRIFILM Aerobic Count Plate according to the manufacturer's instructions. The count plates were incubated at 37° C. for 48 hours. After the incubation period, the number of cfu on each plate was counted using a 3M PETRIFILM Plate Reader (3M Corporation). The count value was used to calculate the total number of cfu recovered from a disc. The results are reported as the mean cfu count determined for 3 discs.

Discs that were not subjected to the cleaning procedure were analyzed for colony count (cfu) using the same described procedure.

### Sample Disc Colony Count Method B

Following the brushing procedure, each disc was washed five times with 1 mL portions of a solution containing TWEEN 20 (0.05%) in PBS buffer. Each washed disc was individually transferred to a separate 50 mL conical vial that contained a solution of TWEEN 20 (0.05%) in PBS buffer (10 mL). Each tube was sequentially vortexed for 1 minute, sonicated for 30 seconds (2 second pulses with 0.5 seconds between pulses at the level 3 setting) using a Misonix Sonicator Ultrasonic Processor XL, Misonix Incorporated, Farmingdale, N.Y., and vortexed for 1 minute. The solution from each tube was serially diluted (about 8 dilutions) with Butterfield's buffer to yield a bacterial concentration level that provided counts of colony forming units (cfu) within the counting range of a 3M PETRIFILM Aerobic Count Plate. An aliquot (1 mL) from each diluted sample was plated on a separate 3M PETRIFILM Aerobic Count Plate according to the manufacturer's instructions. The count plates were sealed in an air tight anaerobic box with two BD GasPak EZ pouches (obtained from Becton, Dickinson and Company) and incubated at 37° C. for 24 hours. After the incubation period, the number of cfu on each plate was counted using a 3M PETRIFILM Plate Reader. The count value was used to calculate the total number of cfu recovered from a disc. The results are reported as the mean cfu count determined for 3 discs.

Discs that were not subjected to the brushing procedure were analyzed for colony count (cfu) using the same described procedure.

### Example 9

Discs (12.7 mm) of Example 1, Example 2, and Comparative Example A inoculated with P. aeruginosa were prepared as described in the ‘Sample Disc Inoculation, Incubation and Washing Method’ (described above). The discs were cleaned according to the ‘Sample Disc Cleaning Procedure A’ (described above) using SONTARA 8000 as the nonwoven sheet. The cleaned discs were analyzed according to ‘Sample Disc Colony Count Method A’ (described above). The mean log₁₀ cfu counts are reported in Table 2 together with the calculated log₁₀ cfu reduction achieved by cleaning the disc.

SEM images of the discs before cleaning showed a large continuous biofilm on the surface of Comparative Example A discs, while the discs of Examples 1 and 2 showed separated aggregates and small groups of cells on the microstructured disc surface. Following the cleaning procedure, biofilm aggregates in small patches covered the surface of Comparative Example A discs, while the discs of Examples 1 and 2 had only small groups of cells and individual cells on the microstructured disc surface.

TABLE 2

| | Mean Log₁₀ CFU Recovered | | Log₁₀ CFU |
|---|---|---|---|
| | (P. aeruginosa) from a Disc | | Reduction |
| | (n = 3), SD = Standard Deviation | | from |
| Sample Disc | Not Cleaned | Cleaned | Cleaning |
| Example 1 | 8.64 (SD = 0.43) | 4.24 (SD = 0.74) | 4.40 |
| Example 2 | 8.73 (SD = 0.15) | 2.97 (SD = 0.50) | 5.76 |
| Comparative | 8.67 (SD = 0.01) | 6.88 (SD = 0.70) | 1.79 |
| Example A | | | |

### Example 10

Discs (12.7 mm) of Examples 3-8 and Comparative Example A inoculated with P. aeruginosa were prepared as described in the ‘Sample Disc Inoculation, Incubation and Washing Method’. The discs were cleaned according to the ‘Sample Disc Cleaning Procedure A’ using SONTARA 8000 as the nonwoven sheet. The cleaned discs were analyzed according to ‘Sample Disc Colony Count Method A’. The mean log₁₀ cfu counts are reported in Table 3 together with the calculated log₁₀ cfu reduction achieved by cleaning the disc.

TABLE 3

| | Mean Log₁₀ CFU Recovered | | Log₁₀ CFU |
|---|---|---|---|
| | (P. aeruginosa) from a Disc | | Reduction |
| | (n = 3), SD = Standard Deviation | | from |
| Sample Disc | Not Cleaned | Cleaned | Cleaning |
| Example 3 | 9.04 (SD = 0.07) | 6.72 (SD = 0.31) | 2.32 |
| Example 4 | 9.06 (SD = 0.02) | 6.85 (SD = 0.33) | 2.21 |
| Example 5 | 9.13 (SD = 0.06) | 6.46 (SD = 0.58) | 2.67 |
| Example 6 | 9.02 (SD = 0.09) | 6.32 (SD = 0.14) | 2.70 |
| Example 7 | 9.07 (SD = 0.03) | 6.46 (SD = 0.06) | 2.61 |
| Example 8 | 8.90 (SD = 0.14) | 6.50 (SD = 0.35) | 2.40 |
| Comparative | 9.07 (SD = 0.10) | 7.84 (SD = 0.13) | 1.23 |
| Example A | | | |

### Example 11

Discs (12.7 mm) of Example 1, Example 2, and Comparative Example A inoculated with S. aureus were prepared as described in the ‘Sample Disc Inoculation, Incubation and Washing Method’. The discs were cleaned according to the ‘Sample Disc Cleaning Procedure A’ using SONTARA 8000 as the nonwoven sheet. The cleaned discs were analyzed according to ‘Sample Disc Colony Count Method A’. The mean log₁₀ cfu counts are reported in Table 4 together with the calculated log₁₀ cfu reduction achieved by cleaning a disc.

SEM images of the discs before cleaning showed a large continuous biofilm on the surface of Comparative Example A discs, while the discs of Examples 1 and 2 showed separated aggregates and small groups of cells on the surface. For the discs of Examples 1 and 2 the S. aureus cells were primarily in the valley portions of the structured surface. Following the cleaning procedure, biofilm aggregates in small patches covered the surface of Comparative Example A discs, while the discs of Examples 1 and 2 had only small groups of cells and individual cells on the surface.

TABLE 4

| | Mean Log₁₀ CFU Recovered | | Log₁₀ CFU |
|---|---|---|---|
| | (S. aureus) from a Disc | | Reduction |
| | (n = 3), SD = Standard Deviation | | from |
| Sample Disc | Not Cleaned | Cleaned | Cleaning |
| Example 1 | 8.01 (SD = 0.23) | 4.55 (SD = 0.07) | 3.46 |
| Example 2 | 7.55 (SD = 0.31) | 4.34 (SD = 0.30) | 3.21 |
| Comparative | 8.04 (SD = 0.14) | 6.14 (SD = 0.43) | 1.90 |
| Example A | | | |

### Example 12

Discs (12.7 mm) of Example 1, Example 2, and Comparative Example A inoculated with P. aeruginosa were prepared as described in the ‘Sample Disc Inoculation, Incubation and Washing Method’. The discs were cleaned according to the ‘Sample Disc Cleaning Procedure A’ using SONTARA 8000 as the nonwoven sheet. The only exception was that half of the discs were oriented in the instrument so that the microstructured channels in the disc surface were oriented in the same direction as the cleaning carriage motion and half of the discs were oriented in the instrument so that the microstructured channels in the disc surface were oriented in the direction perpendicular to the cleaning carriage motion. The cleaned discs were analyzed according to ‘Sample Disc Colony Count Method A’. The mean log₁₀ cfu counts are reported in Table 5 together with the calculated log₁₀ cfu reduction achieved by cleaning the disc.

TABLE 5

| | Mean Log₁₀ CFU Recovered | | Log₁₀ CFU | |
|---|---|---|---|---|
| | (P. aeruginosa) from a Disc | | Reduction | |
| | (n = 3), SD = Standard Deviation | | from | Cleaning |
| Sample Disc | Not Cleaned | Cleaned | Cleaning | Direction |
| Example 1 | 8.88 (SD = 0.53) | 5.95 (SD = 0.74) | 2.93 | parallel |
| Example 1 | 8.88 (SD = 0.53) | 5.66 (SD = 0.18) | 3.22 | perpendicular |
| Example 2 | 8.80 (SD = 0.16) | 4.74 (SD = 0.31) | 4.06 | parallel |
| Example 2 | 8.80 (SD = 0.16) | 5.00 (SD = 0.83) | 3.80 | perpendicular |
| Comparative | 8.51 (SD = 0.63) | 7.19 (SD = 0.77) | 1.32 | not applicable |
| Example A | | | | |

### Example 13

Discs (12.7 mm) of Example 1 and Comparative Example A inoculated with P. aeruginosa were prepared as described in the ‘Sample Disc Inoculation, Incubation and Washing Method’. The discs were cleaned according to the ‘Sample Disc Cleaning Procedure A’ using the polypropylene nonwoven sheet (5.9 micron fiber diameter, 40 gsm). The cleaned discs were analyzed according to ‘Sample Disc Colony Count Method A’. The mean log₁₀ cfu counts are reported in Table 6 together with the calculated log₁₀ cfu reduction achieved by cleaning a disc.

TABLE 6

| | Mean Log₁₀ CFU Recovered | | Log₁₀ CFU |
|---|---|---|---|
| | (P. aeruginosa) from a Disc | | Reduction |
| | (n = 3), SD = Standard Deviation | | from |
| Sample Disc | Not Cleaned | Cleaned | Cleaning |
| Example 1 | 9.06 (SD = 0.05) | 3.08 (SD = 0.28) | 5.98 |
| Comparative | 8.67 (SD = 0.13) | 5.32 (SD = 1.29) | 3.35 |
| Example A | | | |

### Example 14

Discs (12.7 mm) of Example 1, Example 2, and Comparative Example A inoculated with S. mutans were prepared as described in the ‘Sample Disc Inoculation, Incubation and Washing Method’. The discs were cleaned according to the ‘Sample Disc Cleaning Procedure B’. The cleaned discs were analyzed according to ‘Sample Disc Colony Count Method B’. The mean log₁₀ cfu counts are reported in Table 7 together with the calculated log₁₀ cfu reduction achieved by cleaning the disc.

SEM images of the discs before cleaning showed a large continuous biofilm on the surface of Comparative Example A discs, while the discs of Examples 1 and 2 showed separated aggregates of cells growing mostly on top of the peaks of the microstructured surface. Following the cleaning procedure, biofilm aggregates still covered most the surface of Comparative Example A discs, while the discs of Examples 1 and 2 had only small groups of cells and individual cells growing on top of the microstructured surface.

TABLE 7

| | Mean Log₁₀ CFU Recovered | | Log₁₀ CFU |
|---|---|---|---|
| | (S. mutans) From a Disc | | Reduction |
| | (n = 3), SD = Standard Deviation | | from |
| Sample | Not Brushed | Brushed | Cleaning |
| Example 1 | 8.49 (SD = 0.08) | 5.37 (SD = 0.15) | 3.12 |
| Example 2 | 8.47 (SD = 0.24) | 6.04 (SD = 0.33) | 2.43 |
| Comparative | 8.21 (SD = 0.17) | 7.00 (SD = 0.47) | 1.21 |
| Example A | | | |

### Example 15

### Sample Disc Cleaning with a Disinfectant Solution

A disinfectant cleaning solution was prepared by diluting (1:256) 3M Disinfectant Cleaner RCT Concentrate 40A (obtained from the 3M Corporation) with sterile water. Discs of Example 1, Example 2, and Comparative Example A (12.7 mm) inoculated with P. aeruginosa were prepared as described in the ‘Sample Disc Inoculation, Incubation and Washing Method’. The release liner layers were removed and each disc was attached to the wall of a separate 50 mL conical vial (i.e. one disc per tube). To ensure complete submersion of the disc in the disinfectant cleaning solution, the disc was attached as close as possible to the bottom of the tube. An aliquot (4 mL) of the disinfectant cleaning solution was added to each tube and the tubes were maintained at room temperature for either 30 seconds or 3 minutes. Dey\Engley neutralizing broth (36 mL) was added immediately and the capped tube was inverted 3 times by hand motion to mix the sample. Each tube was sequentially vortexed for 30 seconds, sonicated for 30 seconds using a Branson 2510 Ultrasonic Cleaning Bath, and vortexed for 30 seconds. The solution from each tube was serially diluted (about 8 dilutions) with Butterfield's buffer to yield a bacterial concentration level that provided counts of colony forming units (cfu) within the counting range of a 3M PETRIFILM Aerobic Count Plate. An aliquot (1 mL) from each diluted sample was plated on a separate 3M PETRIFILM Aerobic Count Plate according to the manufacturer's instructions. The count plates were incubated at 37° C. for 48 hours. The number of cfu on each plate was counted after the 24 hour incubation using a 3M PETRIFILM Plate Reader. The count value was used to calculate the total number of cfu recovered from a disc.

Control discs were prepared and analyzed following the same procedure with the exception that the discs were not treated with the disinfectant cleaning solution. The results are reported in Table 8 as the mean log₁₀ cfu reduction when disinfectant was used as compared to the mean cfu count observed for the control discs (n=3).

TABLE 8
Cleaning Effect with a Disinfectant Solution

Mean Log₁₀ CFU Reduction (P. aeruginosa)
when using a Disinfectant Cleaning
Solution (n = 3), SD = Standard Deviation

| Sample Disc | 30 seconds | 3 minutes |
|---|---|---|
| Example 1 | 1.60 (SD = 0.31) | 2.16 (SD = 0.27) |
| Example 2 | 0.45 (SD = 0.17) | 1.60 (SD = 0.31) |
| Comparative | 0.14 (SD = 0.13) | 0.46 (SD = 0.36) |
| Example A | | |

### Example 16

An acrylic pressure sensitive adhesive (PSA) film was prepared by combining and mixing isooctyl acrylate (450 g, Sigma-Aldrich Company), acrylic acid (50 g, Alfa Aesar, Haverhill, Mass.) and DAROCUR 1173 photoinitiator (0.15 g) in a clear glass jar. The sample was purged with nitrogen for 5 minutes and exposed to low intensity (0.3 mW/cm²) UV irradiation from a 360 nm UV light until a viscosity of approximately 2000 centipoise was achieved. Viscosity measurements were determined using a Brookfield LVDV-II+Pro Viscometer with LV Spindle #63 (AMETEK Brookfield, Middleboro, Mass.) at 23° C. and shear rate of 50 s⁻¹. IRGACURE-651 photoinitiator (1.125 g) and hexanediol diacrylate (2.7 g, Sigma-Aldrich Company) were added to the jar and the mixture was mixed for 24 hours. The resulting viscous polymer solution was coated between siliconized polyester release liners (RFO2N and RF22N, obtained from SKC Hass, Seoul, Korea), using a knife coater with a set gap to yield an adhesive coating thickness of 100 microns. This construction was irradiated at 350 nm UV irradiation using a total dose of 1200 mJ/cm² of UVA radiation to provide the finished PSA film.

The PSA film was applied to the back surface (i.e. non-microstructured surface) of a linear prism film sheet having microstructure features of Example 1 (Table 1). The resulting laminated film was cut into test strips [1 inch by 3 inch (2.54 cm by 7.62 cm)]. Test strips were applied to the surface flat glass and polypropylene panels using a hand roller. The panels were conditioned at 120° C. for 4 hours and then equilibrated to room temperature. Test strips were peeled from the panel surfaces by hand. Following removal of the test strips, the panel surfaces were visually inspected and no residue from the test strips was observed on any of the panel surfaces.

### Example 17

A metal tool was used with a laminator to create a linear prism film of FIG. 3 with dimensions of Example 3. A layer of 3M Tape Primer 94 (obtained from the 3M Corporation) was applied using a brush to the entire surface on one side of a DURAN PET-G disc (disc diameter=125 mm, disc thickness=0.75 mm). The primer layer was allowed to dry at room temperature for 5 minutes. A second layer of primer was applied in the same manner followed by drying. The UV curable resin (described above) was applied to the tooling by pipette and the PET-G disc was placed over the tooling with the primed surface of the disc facing the tooling. The disc was laminated using a laminator with a nip pressure setting of 50 psig and a speed setting of 0.52 feet/minute (0.16 meters/minute). The sample was cured with UV light by passing the sample 3 times through a UV processor (model QC 120233AN with two Hg vapor lamps, obtained from RPC Industries) at a rate of 15.2 meters/minute (50 feet/minute) under a nitrogen atmosphere.

The laminated, microstructured disc was formed into a dental aligner article using a BIOSTAR VI pressure molding machine (Scheu-Dental GmbH). The microstructured disc was heated for 30 seconds and then pulled over a rigid-polymer dental arch model. The film was oriented so that the microstructured surface contacted the model. The chamber of the molding machine behind the film was pressurized to 90 psi for 30 seconds with cooling and the chamber was then vented to return to ambient pressure. The model with thermoformed film was removed from the machine and excess film was trimmed using a sonic cutter (model NE80, Nakanishi Incorporated,

Kanuma City, Japan). The finished, formed dental aligner was separated from the model. The microstructures of the formed dental aligner were inspected and measured using a Keyence VK-X200 series laser microscope (Keyence Corporation, Itasca, Ill.). The linear prism microstructures retained their shape and nominally 80% of their peak height.

### Reduction of Microbial Touch Transfer

Tryptic Soy Agar was prepared according to the manufacturer's instructions. A streak plate of Pseudomonas aeruginosa (ATCC 15442) or Staphylococcus aureus (ATCC 6538) was prepared from a frozen stock on Tryptic Soy Agar and incubated overnight at 37° C. Two colonies from the plate were used to inoculate 9 mL of sterile Butterfield's Buffer (3M Corporation). The optical density (absorbance) was read at 600 nm to confirm that the reading was 0.040 ±0.010. If required, the culture was adjusted to be within this range. A portion of the culture (1.5 mL) was added to 45 mL of Butterfield's Buffer in a sterile 50 mL conical tube to make the inoculation solution for the touch transfer experiments. Serial dilution samples of inoculation solutions were prepared using Butterfield's Buffer. The dilution samples were plated on 3M PETRIFILM Aerobic Count plates (3M Corporation) and evaluated according to the manufacturer's instructions to confirm the cell concentration used in each experiment.

Microstructured samples (50 mm×50 mm) of Examples 1, 2 were prepared and individually adhered to the internal, bottom surface of sterile 100 mm Petri dishes using double sided tape. Each Petri dish contained a single sample and the sample was attached so that the microstructured surface was exposed. Samples of the corresponding Comparative Examples A was also tested and served as control samples. Samples of Comparative Example A served as the control samples for microstuctured samples of Examples 1 and 2. The exposed surface of each microstructured and control sample was wiped three times using a KIMWIPE wiper (Kimberly-Clark Corporation, Irving, Tex.) that had been wetted with a 95% isopropyl alcohol solution. The samples were air dried for 15 minutes in a biosafety cabinet with the fan turned on. The samples were then sterilized by for 30 minutes using irradiation from the UV light in the cabinet.

Inoculation solution (25 mL of either S. aureus or P. aeruginosa described above) was poured into a sterile Petri dish (100 mm). For each sample, an autoclave-sterilized circular disc of Whatman Filter Paper (Grade 2, 42.5 mm diameter; GE Healthcare, Marborough, Mass.) was grasped using flame-sterilized tweezers and immersed in the Petri dish containing the inoculation solution for 5 seconds. The paper was removed and held over the dish for 25 seconds to allow excess inoculum to drain from the paper. The inoculated paper disc was placed on top of the microstructured sample and a new autoclave-sterilized piece of Whatman Filter paper (Grade 2, 60×60 mm) was placed over the inoculated paper disc. A sterile cell spreader was pressed on the top paper surface of the stack and moved across the surface twice in perpendicular directions. The stack was maintained for two minutes. Both pieces of filter paper were then removed from the microstructured sample using sterile tweezers. The sample was allowed to air dry at room temperature for 5 minutes. Touch transfer of bacteria from the microstructured surface of each sample was assessed by pressing a RODAC plate (Trypticase Soy Agar with Lecithin and Polysorbate 80; from Thermo Fisher Scientific) evenly onto the film sample for 5 seconds using uniform pressure (about 300 g). The RODAC plates were incubated at 37° C. overnight. Following the incubation period, the colony forming units (cfu) were counted for each plate. Samples were tested in triplicate with the mean count value reported.

The mean cfu count for each sample was converted to the log ₜₒ scale. The log₁₀ reduction in cfu count by touch transfer was determined by subtracting the log₁₀ count value obtained for the microstructured sample from the log₁₀ count value obtained for the corresponding control sample (sample with a smooth surface). The mean % reduction (n=3) in touch transfer was calculated by following Equation A. The results are reported in the following Table 9:

% Reduction in Touch Transfer=(1−10^{(-log}₁₀^{reduction value)})*100. Equation A:

TABLE 9

| | | Mean log₁₀ cfu | | |
|---|---|---|---|---|
| | | Count using the | Mean log₁₀ cfu | |
| Microstructured | Inoculation | Microstructured | Count using the | % Reduction in |
| Sample | Organism | Sample | Control Sample | Touch Transfer |
| Example 1 | S. aureus. | 0.20 | 2.27 | 99.2 |
| Example 2 | S. aureus | 0.16 | 1.46 | 95.0 |
| Example 1 | P. aeruginosa | 1.59 | 2.20 | 75.1 |

### Surface Coverage of a Liquid Disinfectant

Samples (7.6 cm by 20.3 cm strips) of microstructured films of Example 1 and Comparative Example A were adhesively attached to a cleaning lane of an Elcometer Model 1720 Abrasion and Washability Tester (Elcometer Incorporated). In addition, a cube corner microstructured film (Example 27a) was prepared according to Example 20 with the dimensions of an individual cube corner microstructure as follows: triangular base of 60/60/60 degrees (beta 1, 2, 3); side wall angles alpha2, alpha3, alphal that were 45, 45, 45 degrees; a peak height of 9 micrometers; and valley widths of 27.7 micrometers and 27.7 micrometers. A corresponding sample strip of Example 27a was also attached to a cleaning lane of the instrument. Each lane contained a single test sample. For the microstructured samples, the microstructured surface was exposed with the opposite non-microstructured surface attached to the cleaning lane. For the microstructured film of Example 1, some samples were placed in the instrument so that the microstructured channels in the film surface were oriented in the same direction (parallel direction) as the carriage motion, while other samples were placed in the instrument so that the microstructured channels in the film surface were oriented in the direction perpendicular to the carriage motion.

Two different wetted wipes were used in the test. The first wetted wipe was a SONTARA 8000 nonwoven (5.1 cm by 12.7 cm) that was soaked in an aqueous solution of isopropyl alcohol (70%) containing 0.025% crystal violet dye (obtained from the Sigma-Aldrich Company). The second wetted wipe was a paper towel (5.1 cm by 12.7 cm section of a WypALL L30 General Purpose Wiper obtained from the Kimberly-Clark Corporation, Irving, Tex.) that was soaked in a solution of isopropyl alcohol (70%) containing 0.025% crystal violet dye. Excess liquid was removed from all wipes by hand squeezing liquid from each wipe. Each wetted wipe was secured around a Universal Material Clamp Tool (450 g) and the tool was attached to the carriage of the instrument. The instrument was set to operate with 15 carriage cycles at a rate of 60 cycles/minute (total time=15 seconds).

Images of the surface of each sample were taken 1 minute and 3 minutes after completion of the test to determine the coverage of dye on the sample surface. The color images were converted to 8-bit and three randomly selected 200×200 pixel regions of each image were analyzed. A threshold was set and the percent surface area covered by dye was measured using the open source image processing software ImageJ (NIH, Bethesda, Md.; https://imagej.nih.gov/ij/). The results are reported in the following tables as the percentage of the test sample surface covered with dye, where 100% represents dye completely covering the test sample surface. The reported value is the mean value calculated from the three analyzed regions.

TABLE 10A

| | | Percent of Sample Surface | | Sample |
|---|---|---|---|---|
| | | Covered with Dye Post Wiping | | Orienta- |
| Sample | Wipe | 1 Minute | 3 Minutes | tion |
| Example 1 | SONTARA | 96.8 | 98.2 | parallel |
| | 8000 | | | |
| Example 1 | SONTARA | 97.1 | 97.4 | perpen- |
| | 8000 | | | dicular |
| Comparative | SONTARA | 5.0 | 4.5 | not |
| Example A | 8000 | | | applicable |

TABLE 10B

| | | Percent of Sample Surface | | Sample |
|---|---|---|---|---|
| | | Covered with Dye Post Wiping | | Orienta- |
| Sample | Wipe | 1 Minute | 3 Minutes | tion |
| Example 1 | Paper Towel | 96.7 | 97.6 | parallel |
| Example 1 | Paper Towel | 98.2 | 98.4 | perpen- |
| | | | | dicular |
| Comparative | Paper Towel | 19.0 | 13.2 | not |
| Example A | | | | applicable |

1. A medical article comprising:
a base member; and
a microstructured surface disposed on one or more surfaces of the base member,
the microstructured surface comprising an array of peak structures and adjacent valleys,
wherein the valleys have a maximum width ranging from 10 microns to 250 microns and the peak structures have a side wall angle of greater than 10 degrees.

2. The medical article of claim 1, wherein adjacent peak structures are interconnected proximate the base member in at least one direction.

3. The medical article of claim 1, wherein the peak structures comprise two or more facets.

4. The medical article of claim 3, wherein the facets form a continuous or semi-continuous surface in the same direction.

5. The medical article of claim 1, wherein the microstructured surface comprises a linear array of prisms or an array of cube-corner elements.

6. The medical article of claim 3, wherein peak structures have an apex that is sharp, rounded, or truncated.

7. The medical article of claim 1, wherein the peak structures have an apex angle ranging from 20 to 120 degrees.

8. The medical article of claim 7, wherein the peak structures and valleys are free of flat surface area.

9. The medical article of claim 8, wherein the peak structures and/or valleys are truncated such that the microstructured surface comprises less than 50, 40, 30, 20 or 10% of flat surface area.

10. The medical article of claim 1, wherein the base member and peak structures comprise the same or different materials.

11. The medical article of claim 1, wherein the base member and peak structures comprises an organic polymeric material.

12. The medical article of claim 1, wherein the microstructured surface and base member are transparent, light-transmissive, or opaque.

13. (canceled)

14. The medical article of claim 1, wherein the medical article is a dental tray.

15. The medical article of claim 1, wherein the dental tray is configured in the shape of an arch.

16. The medical article of claim 1, wherein the dental tray comprises a plurality of cavities shaped to receive one or more teeth.

17. The medical article of claim 16, wherein the medical article is a dental aligner.

18-24. (canceled)

25. A method of cleaning a medical article comprising:
providing a medical article comprising a base member and a microstructured surface of claim 1; and
cleaning the microstructured surface.

26. The method of claim 25, wherein the cleaning comprises:
a) wiping the microstructured surface with a woven or non-woven material;
b) scrubbing the microstructured surface with a brush;
c) applying an antimicrobial solution to the microstructured surface; or any combination thereof.

27. The medical article of claim 1, wherein the microstructured surface provides a log 10 reduction of bacteria of at least 2, 3, 4, 5, or 6 after the cleaning.

28. The medical article of claim 1 wherein the bacteria is a virus or Phi6 Bacteriophage.
